(19) United States
(12) Patent Application Publication
(10) Pub. No.: US 2017/0024589 A1
(43) Pub. Date: Jan. 26, 2017

(54) Smart Beauty Delivery System Linking Smart Products

(71) Applicants: Robert Schumacher, Santa Monica, CA (US); Walter Dwyer, Pacific Palisades, CA (US)

(72) Inventors: Robert Schumacher, Santa Monica, CA (US); Walter Dwyer, Pacific Palisades, CA (US)

(21) Appl. No.: 14/951,782

(22) Filed: Nov. 25, 2015

Related U.S. Application Data
(60) Provisional application No. 62/195,493, filed on Jul. 22, 2015.

(51) Int. Cl. G06K 7/10; G06F 3/0481; H04R 1/08; G06F 3/0484

(52) U.S. Cl. CPC G06K 7/10366; G06F 3/04842; G06F 3/04817; H04R 1/08

(57) ABSTRACT

Internet of Things beauty and personal care application system which may include products, a mirror, digital camera, reader identifying product, communication transceivers, sensors, servers and databases. These link images and data via a mobile application, allowing a plurality of applications via a single interface. Users can enhance makeup application by using professional guidance based on users applied makeup, the environment, products selected, other products available, or presented to users from a product database. Further, the system may provide virtually enhanced images via its mobile application, based on users' skin tone, time of day, lighting, weather, activity, etc., enabling an enhanced user experience, and facilitating user engagement. The result is a beauty and personal care application system providing direct digital identification, 2-way linkage that collects data, applying machine learning algorithms via the network system. This data then supports back office products manufacturing and distribution, providing data driven solutions and changing outcomes.

### CROSS REFERENCE TO RELATED APPLICATIONS

This application claims priority on U.S. Provisional Application Ser. No. 62/195,493, filed on Jul. 22, 2015, the disclosures of which are incorporated herein by reference.

### BACKGROUND

Field

Embodiments of the present invention generally relate to an Internet of Things (IoT) system, and to a method for a smart beauty delivery system. The present invention particularly relates to an Internet Of Things (IoT) enabled smart beauty delivery system, which may include a smart beauty and personal care box broadly comprising a smart looking glass (which may be configured as: a normal mirror, or a semi-transparent mirror, and a display screen that may be a LCD or TFT or other type of display screen, or a touch screen, and any combination thereof), a digital camera and/or reader identifying a product handpicked by the user, short and long distance communication transceivers, a variety of sensor devices, servers and databases, and linking of an enhanced image and data via a mobile application working on a mobile device such as Android and iOS smartphones and tablets without the need for internet connectivity or via a computer to allow a plurality of applications to be controlled via a single interface on the mobile device, or to and from the smart beauty and personal care box or vanity mirror.

### DESCRIPTION OF RELATED ART

Women have applied Beauty products since time immemorial. Today it continues to be a popular activity amongst women. The cosmetics industry today is characterized by multiple cosmetics companies engaged the activity of manufacturing and marketing various cosmetic beauty products for women of all ages. The commonly used beauty products include lip stick, lip gloss, lip liner, lip plumper, lip balm, lip conditioner, lip primer, lip boosters, concealers, foundation, mascara, nail polish, eyebrow pencils, eye shadow, shin care and skin treatments and so on. All these women's beauty related products are used for the purpose of creating, varying or maintaining an image for them or to solve a perceived problem or condition.

By 2016, the cosmetics industry revenue growth just in United States is going to reach a %62.46 billion. Due to the intense business competitions amongst the billion dollar cosmetics companies, these competitors need to employ a myriad of innovative strategies to increase their customer base, including providing an increased level of customer satisfaction.

There is a stark contrast however between the cosmetics companies' approach, and the approach of others, as shown for example by U.S. Pat. No. 7,054,668 to Endo, U.S. Pat. No. 8,427,535 to Davis, and U.S. Patent App. Pub. No. 2011/0228155 by Lee, and the approach taught herein. The present invention utilizes, in part, today's technology driven social media. In social media, “selfies” and smart integrated mobile applications are growing at a record-breaking pace, which is leverage by the apparatus and method taught herein.

As beauty companies encourage purchases through product bundling these companies will need to rely on customer data to make a more personalized and engaging experience. Implementing an efficient bundling practice requires beauty companies to maintain knowledge of each customer's buying history so that they can continuously offer products at the moment their buyers need them. The invention disclosed herein will enhance this commerce, as geo-targeted messaging grows in frequency. The idea is Geo-fencing technologies allow brands to serve existing and potential customers targeted deals and incentives to drive sales.

In addition, the personal care industry has the same challenges with both women and men using and applying products such as hair, dermalogical and medical products. Like cosmetics, these products may benefit from an interface with professionals and other users to get recommendation, monitor progress and improve results. Beside consumers, retail locations can benefit from such an engaging application system.

Content is what drives engagement and engagement is what drives results: increased positive sentiment, increased share of voice, increased awareness, interest, consideration, intent and increased loyalty, brand advocacy and referrals.

To provide the right content, the cosmetics companies must structure their message based on individualized data; data that looks at what is important to each customer. Without it cosmetic brands are essentially creating content without knowing what appeals to their target audience.

The reality is that cosmetic companies have had limited knowledge of: the behaviors of their customers, who is using their products, what products they buy, how often are they are using the products, and how much product is used. Without this information cosmetic companies possess limited ability to do targeted marketing and influence purchasing decisions. The present invention provides cosmetics companies with data driven analytics that can reveal the regime that customers follow, how much of the contents in the product is actually used, expiration dates and usage past that date. This database and the algorithms provided by the system of the present invention enables a change in the dynamics of the cosmetics company's product offerings; as well as efficient product and shelf management allowing for less waste, enhanced profits and better value and savings for their customers.

In the cosmetics industry, there remain areas where innovative ideas can be implemented to increase consumer satisfaction. The present invention enables cosmetics manufacturers to have direct digital access to customers and their behavior, can allow for direct and timely marketing of products, product content and lifespan, loyalty rewards, special offers tailored to the customer, and furthermore opens up the opportunity for e-commerce and focused content delivery. The system of the present invention provides for open 2-way communications between customers and manufacturers/retailers.

In the cosmetics industry today, no such system exists that provides a direct digital identification linkage, collects data and then applies machine learning algorithms to an IoT based network system which supports both consumer needs and back office products manufacturing and distribution needs.

There is thus an unmet need for a cosmetics delivery system and method to provide both an enhanced beauty and personal care experience for customers, as well as support the information gathering required for effective product development, marketing and distribution for beauty and personal care products.

### SUMMARY

Embodiments in accordance with the present invention provide an IoT enabled smart beauty and personal care delivery system (SBPC) which includes SBPC products, applications and interfaces for smart mobile devices such as—smart phones, smart tablets and smart pads (smart mobile devices)—and application services, databases and computing platforms (cloud computing services) that provides database and machine learning tools and interfaces on the customer/consumer and data collection and analysis tools for the cosmetic and personal care industry.

The SBPC products are available individually or within a box of interchangeable holders. A plurality of individual cosmetic products and or cosmetic holders can fit in a SBPC box. Consumers can refresh or buy new products and new holders that will fit in the SBPC box. The “holder” for the cosmetic product(s) may take any form now known or later discovered/utilized within the cosmetics or other industry, including, but not limited to being, a lip stick type of holder, a cosmetic pencil; a tray that holds a cosmetic product such as eye shadow; a cosmetic container such as for a nail polish or nail remover, etc. It should also be noted that the SBPC box may also include openings configured to house a cosmetics implement, including, but not limited to, a scissors, a nail clipper, tweezers, brushes, combs etc. The SBPC box may vary in size to accommodate the products.

The SBPC box may further include a looking glass mirror. The looking glass mirror may at least be a normal mirror, a semi-transparent mirror, a LCD screen, a TFT screen, a touch screen and a combination thereof, an example of which is shown by U.S. Pat. No. 4,202,607 to Washizuka and U.S. Pat. No. 5,210,967 to Brown. The normal mirror is configured in such a way that an image centered on the looking glass mirror will produce an image centered as if set up via camera viewing screen without the need for a camera to be placed behind the mirror. In some cases, there will be a touch display that can act as an extension of the smart mobile device and display the mobile device applications directly on that screen while interacting and accepting touch input and gestures into those applications, the same as is done directly with the smart mobile device.

The SBPC box may further include a high resolution image capturing module configured to take images. These images are stored locally in the SBPC memory, and can also be sent via a specially designed application on the smart mobile device for further processing and services. Stored images can be sent to the cloud computing services via applications on the smart mobile device.

The high resolution image capturing device can be controlled, sourced by the smart mobile device directly via the specially designed application.

The high resolution images can be posted to social media or manufacturer'/retailers' websites or bulletin boards or attached to emails as part of the users or makers or sellers initiative to establish regimens or routines for product usage.

The SBPC box may further include a sensor module which is configured to sense the cosmetic and personal care products selected by the user by means of scanning, which may include, but is not limited to: use of a Near Field Communication (NFC) tag or tags and an NFC reader (see e.g., U.S. Pat. No. 7,346,061 to Takayama, and U.S. Pat. No. 7,734,307 to Dawidowsky); and/or an RFID tag or tags and an RF tag reader (see e.g., U.S. Pat. No. 6,538,563 to Heng, U.S. Pat. No. 7,009,518 to Liao, and U.S. Pat. No. 7,812,779 to Turner); and/or any existing or later developed proximity card technology. (Note, the disclosures of all reference documents cited in this specification are incorporated herein by reference in their entirety). The cosmetic and personal care products are part of the system and are tagged with plurality of codes (bar and QR) or tags (NFC Or RFID) that can be read by plurality of sensors configured on the SBPC or application on the smart phone or tablet.

The SBPC may further include a method for a smart beauty and personal care boxes and vanity mirrors to further include RFID antennas systems of varying power, range and RFID Tag types.

The SBPC may further include support for low power and short range RFID antenna and power. In one embodiment, the vanity mirror will have longer ranges for RFID or Wi-Fi communication, as it acts as a hub for a wide range of products that are at varying distances from the reader.

The SBPC may further include a method for a smart beauty and personal care boxes and vanity mirrors or the Mobile Application to read smart beauty and personal care information tags which are on containers including—and without limitation to this specific containers—easily read plastics, and more difficult liquid and metal containers.

The SBPC may further include a method to setup the smart beauty and personal care product tags per type of container, in a manner that enables the smart beauty and personal care box to read these tags.

The SBPC may further include a method to setup the smart beauty and personal care product tags per type of container, in a manner that enables the smart beauty and personal care application to read these tags

The SBPC may further include a light led that changes colors in and not limited to the following cases, upon activation of the SBPC box, when the product is being scanned or discovered (identified) by the SBPC and upon successful picture (image) taking, to communicate the state of the communication link with the smart mobile device.

The SBPC may further include a wireless communication module configured to communicate over an RF communication network to a smart mobile device or directly to a network, via a specially designed mobile application. In embodiments in accordance with the present invention, the RF link may be WiFi, or Blue Tooth, etc.

Embodiments in accordance with the present invention is a system that may further include a graphical user interface (GUI) module configured to permit a user to select information, tutorials or at least a cosmetic product from a displayed virtual list of cosmetic products. The GUI, for the most part, is an application GUI that is running on the smart mobile device. In cases were the SBPC box comes with a smart interactive display looking glass, this GUI application interface can be extended to the SBPC box. The SBPC box, on the other end, comes with minimal interface and gestures response mechanisms like a light that changes colors when a product is being scanned, or a picture is being taken by the high resolution camera. The SBPC box will come with on/off button and will buttons/interfaces to activate and handle the high resolution camera.

The system may further include a voice recognition module configured to recognize at least one voice instruction provided by the user. Voice recognition can be located within the SBPC box and or in the smart mobile device. The voice recognition subsystem provides activation interfaces for hands free control of the SBPC functionality.

The system may further include an authentication module configured to authenticate user profiles. This authentication module can be configured as part of the smart mobile and/or part of the SBPC.

The system may further include a speaker module configured to provide audio outputs. This speaker module can be configured as part of the smart mobile and/or as part of the SBPC box.

The SBPC box and vanity mirror may further include a system controller CPU module configured to control at least one other system module. The SBPC further includes a memory module configured to store information. The memory module can also be a tangible non-transitory storage medium. The system further includes a power supply module configured to provide power. The SBPC further includes a onetime password (OTP) module.

Embodiments in accordance with the present invention further provide an IoT enabled smart beauty delivery system which may include a smart beauty and personal care vanity mirror. The smart beauty and personal care vanity mirror may be constructed the same as the SBPC box and may include all of the system hardware of the SBPC box, but may be without the products and the interchangeable holder(s) of products. Also, it can act as a hub for the beauty and care system handling communication and processing for smart products like the SBPC or individually tagged products. The vanity mirror may have a longer range RFID reader/antenna, as it may act as a hub for a wide range of products that are at varying distances from the reader.

The system may further include specially designed Application Programmable Interfaces (API) within the smart mobile device, to allow a plurality of applications to be controlled via a single interface on the mobile device, or to and from the smart beauty and personal care box or vanity mirror.

Embodiments in accordance with the present invention may further provide an Application Programmable Interface (API) that may reside on the smart mobile platform and enable a single interface with a plurality of beauty and personal care product applications. This API handles the GUI interface to the user on one end and provides the data collection feature that is sending information to the platform provider and interacts with products database and application servers.

Embodiments in accordance with the present invention may further provide an analysis of the information sent to the platform provider and interacts with products database and application servers. This may result in the creation of algorithms that forecast or predict behavior and establish regimens for how beauty and personal care products are used, how much of the contents in the product is actually used, expiration dates and usage past that date. This database and the algorithms it enables could change the nature of the product offerings; as well as efficient product and shelf management allowing for less waste, enhanced profits and better value and savings for their customers

Embodiments in accordance with the present invention may further provide an analysis of the information sent to the networks associated with the mobile application interacts with products database and application servers. This may result in the creation of algorithms that forecast or predict behavior and establish regimens for how beauty and personal care products are used, how much of the contents in the product is actually used, expiration dates and usage past that date. This database and the algorithms it enables could change the nature of the product offerings; as well as efficient product and shelf management allowing for less waste, enhanced profits and better value and savings for their customers. In addition, the information can be formatted, sorted and delivered on different timetables dependent on the nature of the recipient such as end user, sales person, retailer, manufacturer etc.

Embodiments in accordance with the present invention may further provide for customer interaction to engage the customer as part of the user experience. This may be in the form of loyalty programs, rewards, or participation in social groups. This may also include methods to institute subscription pricing for frequent users of products identified by the system, or to directly re-order product after a certain amount of product has been used, or after the product has been used a certain number of times.

Embodiments in accordance with the present invention may further provide a method for SBPC boxes or vanity mirrors. The method may include authenticating a user; identifying at least a beauty and personal care product chosen by the user from the SBPC box; wherein the beauty and personal care product may consist of at least one unique identification tag; transmitting the captured unique identification over the communication network; capturing an image or a video of the user by an image/video capturing device after the user applies the product; transmitting the captured image/video over the communication network; processing the captured identification in the system's product data base thus creating analytics of the user's interaction with the tagged cosmetic/beauty product; linking the enhanced image with a mobile application; interacting with the user; wherein the interaction may consist of at least one of a video interaction or an audio interaction, or a combination thereof; interacting with the user, wherein the interaction may also include a conference call facility in between at least the user and third party participants, or a combination thereof; wherein the interaction may also include pairing the user with a third party, wherein both of the users may virtually share their beauty makeover products with each other; providing suggestions to the user to enhance their applied beauty and personal care product; sharing the enhanced image in social networks; and storing the enhanced image in the system's memory.

Embodiments in accordance with the present invention may further provide a method for a smart beauty makeover. The method may include authenticating a user; identifying at least a beauty makeover product handpicked by the user from the smart beauty and personal care box or vanity mirror; transmitting the captured unique identification over the communication network; capturing an image of the user by the image capturing device after the user applies a makeover; transmitting the captured image over the communication network; linking the enhanced image with a mobile application; interacting with the user; providing suggestions to the user to enhance their applied makeover, wherein the enhancement of the makeover may consist at least one of a physical makeover, a virtual makeover, or a combination thereof; wherein the suggestions may include information about the beauty makeover products handpicked by the user from the smart beauty and personal care box; wherein the suggestions may also include information about at least a beauty makeover product that is physically not present in the box but is available in a virtual product catalogue provided by a makeup manufacturer; sharing the enhanced image on social networks; and storing the enhanced image in the system's memory, wherein the system memory may store user information and preferences, information related to the specific products commonly applied by this user, including past ‘looks’ chosen and past interactions between the user and the system, to allow smart decision making and choices/suggestions to be delivered to this user interactively or off line when the network connection to the remote database and remote support tools is not available.

Embodiments of the present invention may provide a number of advantages depending on its particular configuration. First, the system may help users to enhance their appearances without requiring help from a makeup artist. Second, the system may have an interactive communication session with the user regarding the makeover enhancement. Third, the system may directly share the captured images with social networking websites. Fourth, over time, the system learns user preferences and helps direct the company/vendor to efficiently prepare, manufacture and distribute certain products and eliminate others. Fifth, the system may help users to enhance their appearances with help from a makeup artist or other existing technologies via the mobile application.

The application system is capable of use in any environment and is highly portable. The system may be used in the home, but also may also travel with the user, be used in a commercial location or in a field location such as in the entertainment industry.

These and other advantages of the invention will become apparent from the following description and claims, and from the accompanying drawings.

The preceding is a simplified summary to provide an understanding of some aspects of embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

FIG. 1 illustrates a smart beauty and personal care box, according to an embodiment of the present invention.

FIG. 1A shows the smart beauty and personal care box of FIG. 1, but illustrates that a product may be received in one of the openings without the use of a product holder, and further illustrates an alternate embodiment for a product holder.

FIG. 1B shows the smart beauty and personal care box of FIG. 1, but illustrates that different product trays may be received into the box, each of which may have opening configured to receive different shaped products or product holders therein.

FIG. 1C shows an alternate embodiment of the smart beauty and personal care box of FIG. 1, where different product trays have been utilized in the housing, to receive different shaped products or product holders therein.

FIG. 1D shows an ID tag (NFC or QR or RFID tag) that may be attached to a product, or product holder that may house a cosmetic product.

FIG. 1E illustrates some of the electronic components that may be utilized in the smart beauty and personal care box of FIG. 1.

FIG. 1F is an enlarged detail view of an NFC reader and NFC antenna that may be used with the smart beauty and personal care box of FIG. 1.

FIG. 1G illustrates the camera angle and positioning with respect to the mirror in the smart beauty and care box of FIG. 1, which may be used to center the image taken by the digital camera.

FIG. 2 illustrates a smart beauty and personal care vanity mirror, according to another embodiment of the present invention;

FIG. 3 is a component block diagram of a digital camera module embodiment for the smart beauty and personal care box and/or vanity mirror of the present invention;

FIG. 4 is a component block diagram of a NFC reader embodiment for the smart beauty and personal care box and/or vanity mirror of the present invention;

FIG. 5 is a component block diagram of a combination digital camera module and NFC Reader embodiment for the smart beauty and personal care box and/or vanity mirror of the present invention;

FIG. 6 is a mechanical diagram of a digital camera module embodiment for the smart beauty and personal care box and/or vanity mirror of the present invention;

FIG. 7 is a mechanical diagram of a combination digital camera module and NFC Reader embodiment for the smart beauty and personal care box and/or vanity mirror of the present invention

FIG. 8 illustrates a functional block diagram of the smart beauty and personal care box and vanity mirror system view with focus on communication interfaces, according to an embodiment of the present invention;

FIG. 9 illustrates an implementation scenario in which a real time communication path is formed between the smart beauty and personal care box, the vanity mirror, a remotely located product database, and a smart phone or a tablet or other smart programmable communication devices, according to an embodiment of the present invention;

FIG. 10 depicts a flow chart of a method for managing a communication session in the smart beauty and personal care box, according to an embodiment of the present invention.

FIG. 10A depicts the continuation of the method shown in FIG. 10.

FIG. 11 and FIG. 12 depict front end processes and back end processes related to the smart beauty and personal care box of FIG. 1.

FIG. 13 Depicts a full system overview adding dashboards for control and monitoring of the system and billing system derived from transactional information stored and managed for every IoT element in the network.

### DETAILED DESCRIPTION

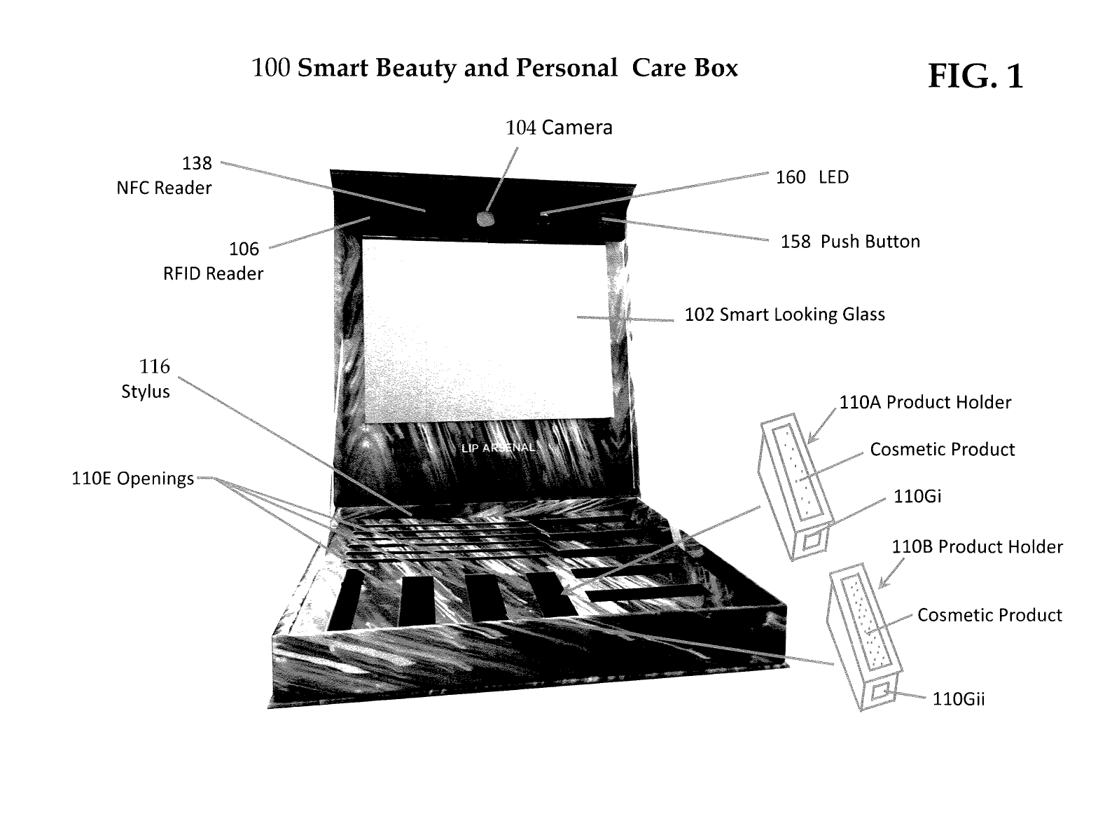

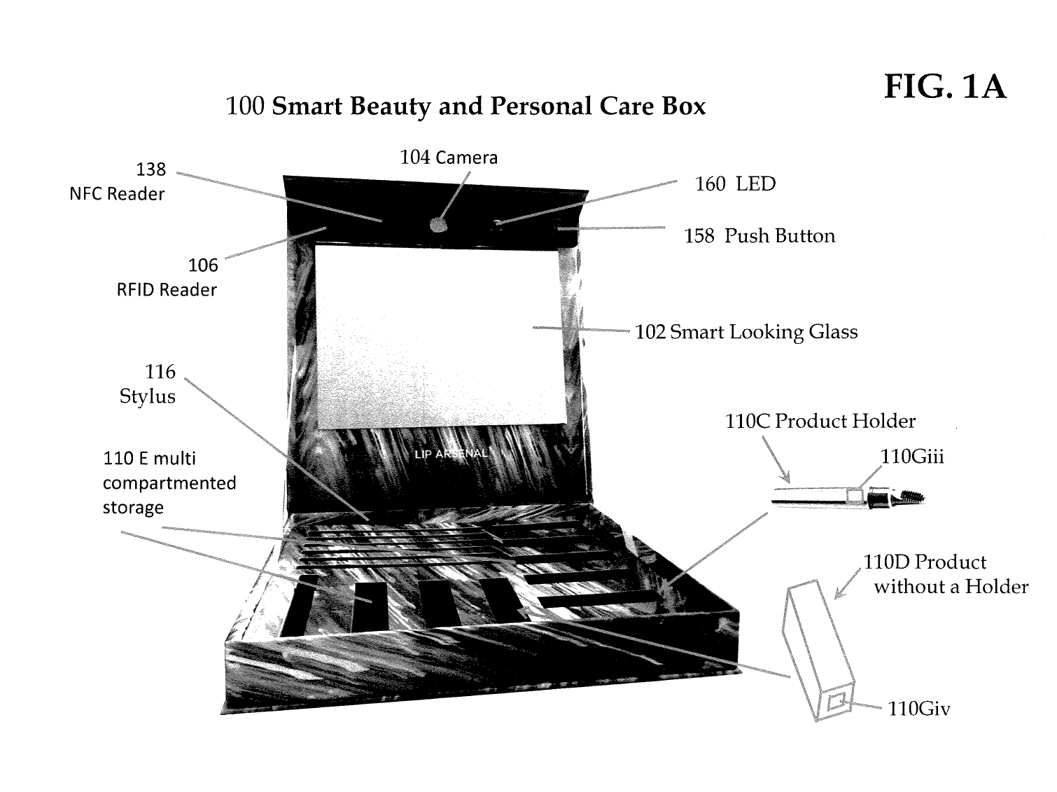

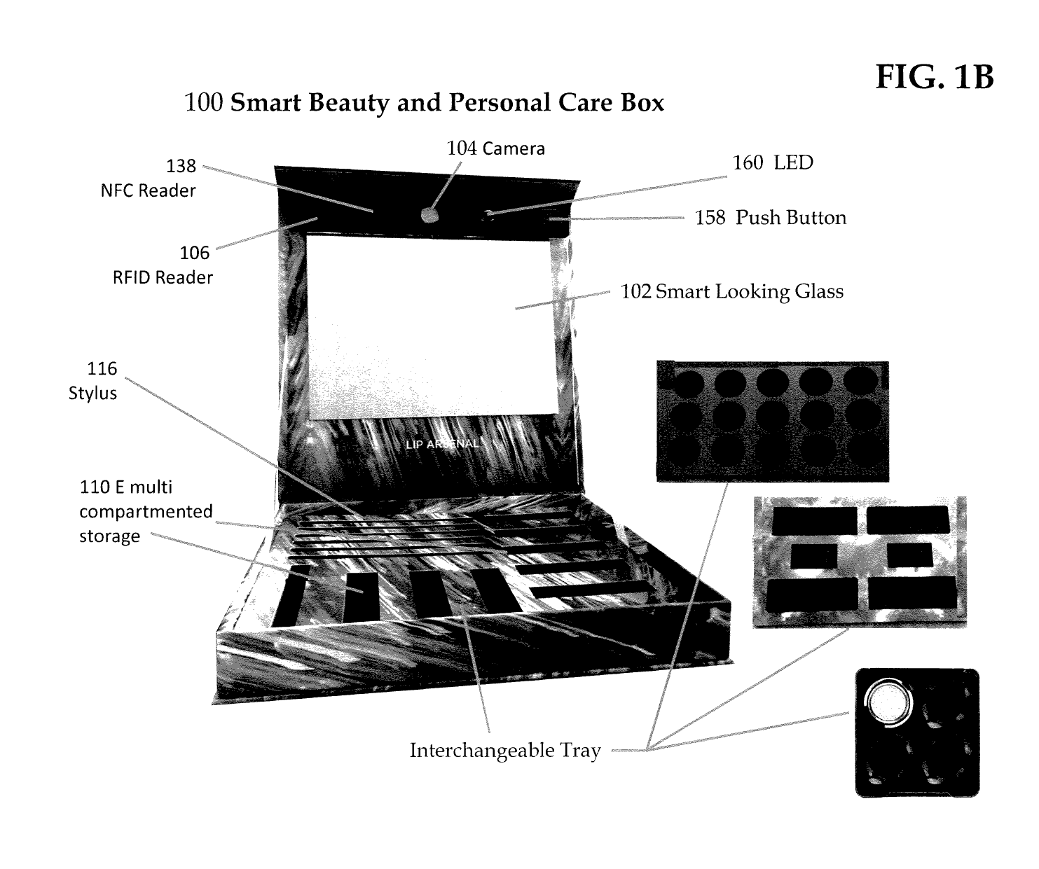

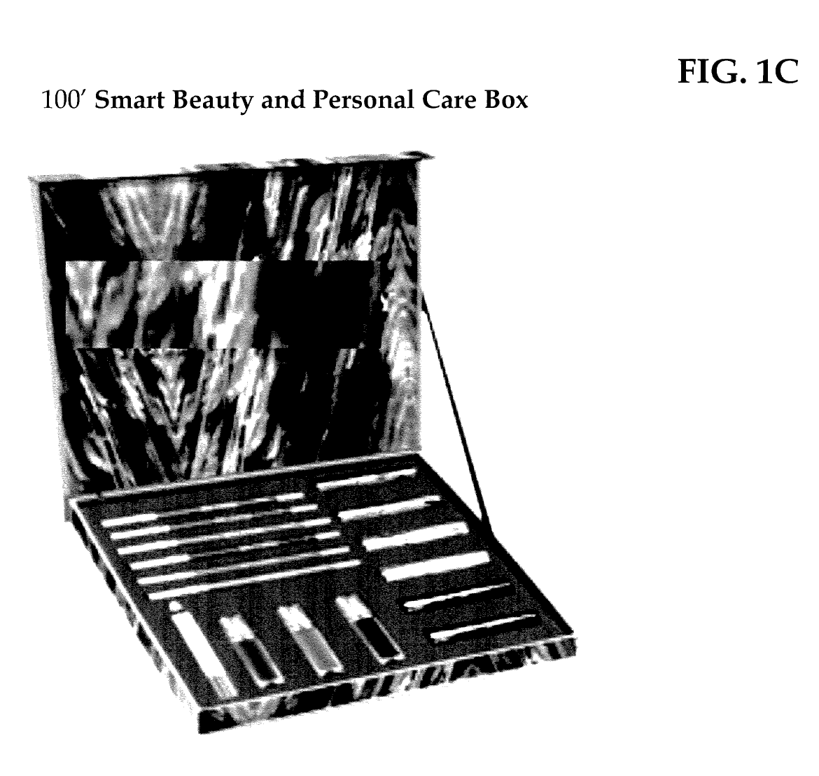

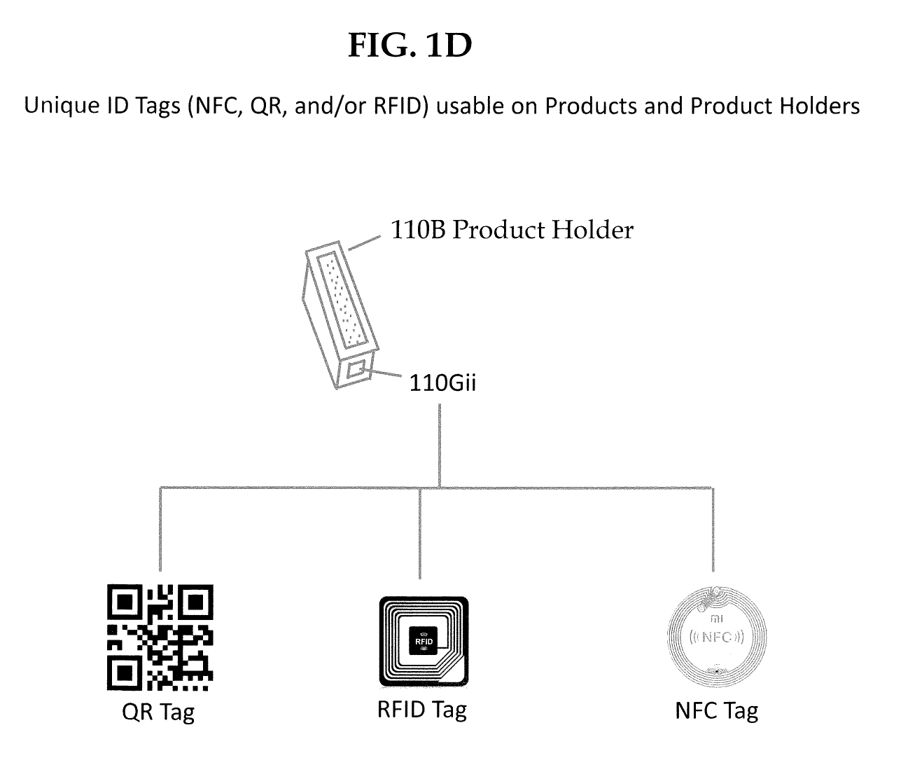

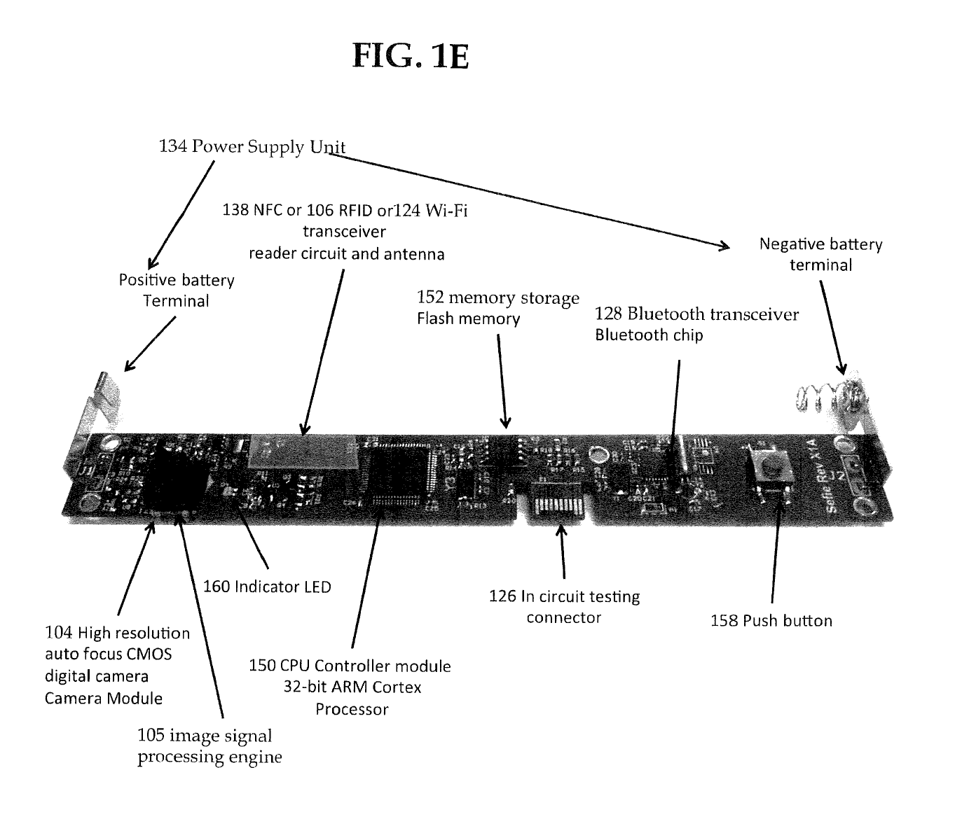

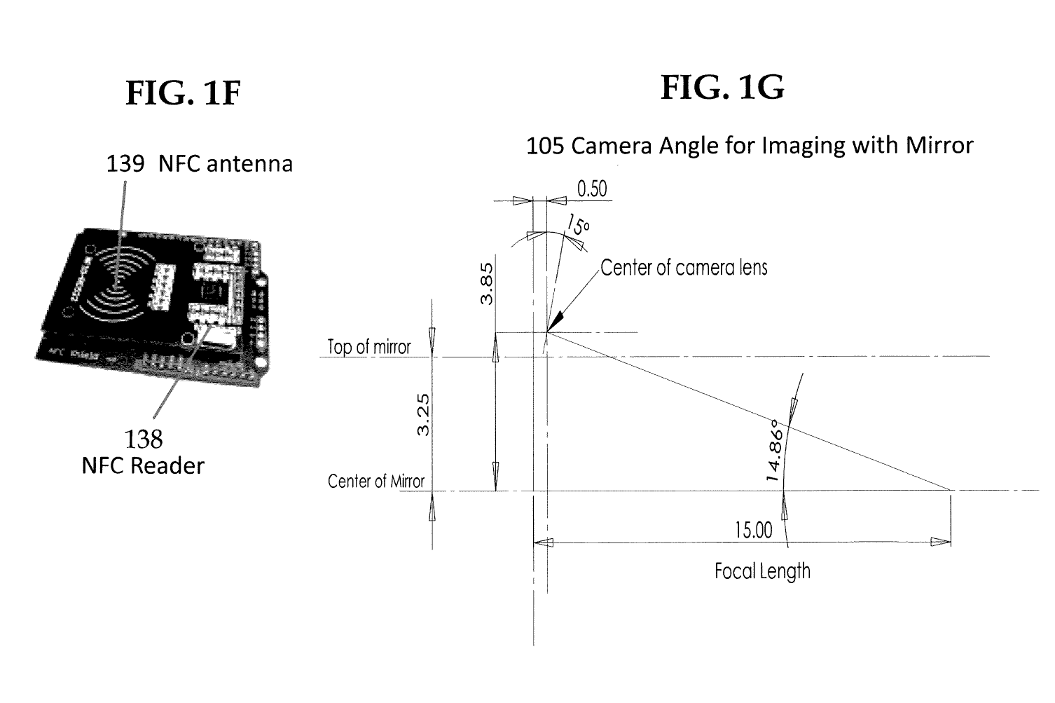

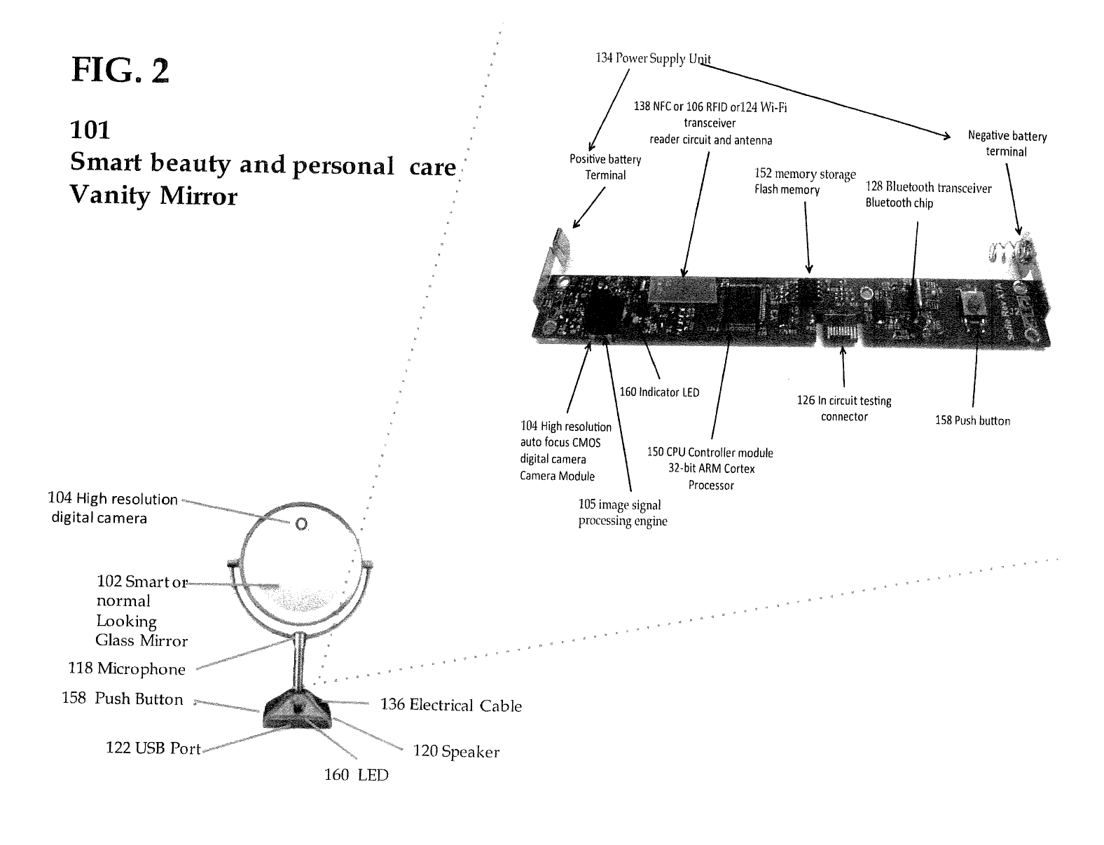

Embodiments of the present invention will be illustrated below in conjunction with an exemplary smart beauty and personal care box shown in FIG. 1.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, reference numerals have been used, where possible, to designate like elements common to the figures.

The phrases “at least one”, “one or more”, and “and/or” are open-ended expressions that are both conjunctive and disjunctive in operation. For example, each of the expressions “at least one of A, B and C”, “one or more of A, B, and C”, and “A, B, and/or C” means A alone, B alone, C alone, A and B together, A and C together, B and C together, or A, B and C together.

The term “a” or “an” refers to one or more of that entity. As such, the terms “a” (or “an”), “one or more” and “at least one” can be used interchangeably herein.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the present invention is described in terms of exemplary embodiments, it should be appreciated those individual aspects of the present invention can be separately claimed.

The term “computer-readable medium” as used herein refers to any tangible storage and/or transmission medium that participate in storing and/or providing instructions to a processor for execution. Such a medium may take many forms, including but not limited to non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, RAM, PROM, EPROM, FLASH-EPROM, solid state medium like a memory card, any other memory chip or cartridge, or any other non-transitory computer readable storage medium from which a computer can read instructions. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure may be stored.

The term “smart phone” as used herein refers to any smart phone and/or smart phone tablet and/or smart phone pad and/or any smart device that is capable to run applications and is able to interface with the World Wide Web via wireless or wired communication and further communicates with other devices via wireless or wired communication interfaces.

FIG. 1 shows an illustrative embodiment of the present invention. A smart beauty and personal care box 100 shown therein may broadly include a looking glass mirror 102, a high resolution auto focus digital camera 104, a RFID reader 106, one or more product holders (e.g., product trays 110A, 110B, applicator 110C in FIG. 1A, etc.) that may be interchangeably received within correspondingly shaped openings 110E in the box housing, and one or more products 110D without trays that may interchangeably received within corresponding shaped openings 110E in the box housing, and a stylus 116 that may be used for writing on the touch screen. The box 100 may include a cover, which may support the camera 104 and mirror, or alternatively the camera may be received within the box housing and the mirror may be mounted to the housing. The box 100 may also include a plurality of light sources distributed about the mirror, and filters, to enable specific lighting conditions, such as soft morning light, harsh afternoon light, evening light, etc., as disclosed by, for example, U.S. Pat. No. 3,757,103 to Walter. Each of the product interchangeable holders may be formed to house a cosmetic product therein, and each may also house, or have affixed thereto, one or more identification (ID) tags (e.g., 110Gi for tray 110A, 110Gii for tray 110B, 110Giii for applicator 110C etc., as seen in FIGS. 1 and 1A). Each of the products not in interchangeable holders may also house, or have affixed thereto, one or more identification (ID) tags (e.g., 110Giv for product 110D, etc., as seen in FIG. 1A). The ID tag may be an NFC tag, a QR barcode tag, and/or an RFID tag, as seen in FIG. 1D. Where a QR bar code tag is utilized, multiple copies of it may be used, and may be placed on different surfaces of the product holder to better facilitate easy/quick scanning of the tag. (Note that an ID tag may also be directly affixed to a solid cosmetic product—e.g., product 110D in FIG. 1A—that may be removed from the box and utilized by the user without the need for, or use of, a product holder). The box 100 may also include a tagged cosmetic implement, including, but not limited to, a scissors, a nail clipper, etc., which may be utilized by the person in combination with a make-up product in one of the product holder, or may instead be utilized separately.

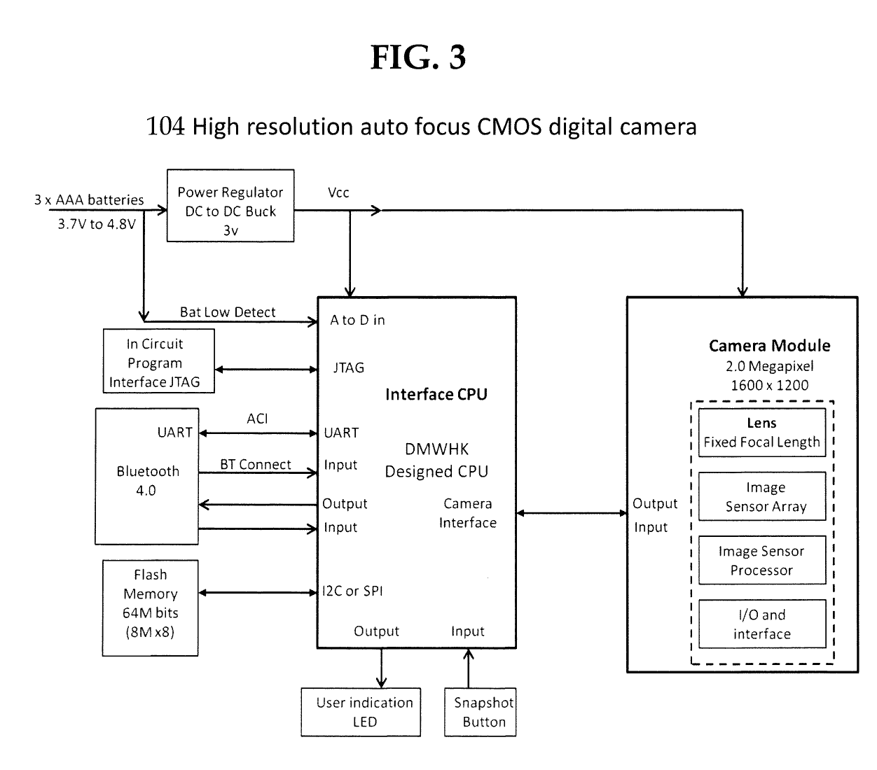

The SBPC box 100 or vanity mirror 101 (as shown in FIG. 2) may house electronic components that may include, but is not limited to: a microphone 118, a speaker 120, a USB port 122, a Wi-Fi transceiver 124, a Bluetooth 128, a power supply unit 134, an electrical cable 136, an ID tag reader (e.g., a near field communication (NFC) tag reader 138), a central processing unit (CPU) 150, a memory storage 152 which can be volatile and non-volatile memory, tangible and non-transitory storage medium, a push button 158, and a light emitting diode (LED) 160. These electronic components are shown in FIG. 1E, a portion of which may be respectively housed within the base of the SBPC box 100 and vanity mirror 101, while certain components (e.g., a digital camera, the NFC reader, the RFID reader) may instead be more advantageously housed behind, within, and/or adjacent to the smart looking glass 102. In FIG. 1G, there is a draft of the camera angle 105 utilized to make possible a picture of whatever is in the center of the mirror without a viewer as in traditional cameras on a camera above the mirror.

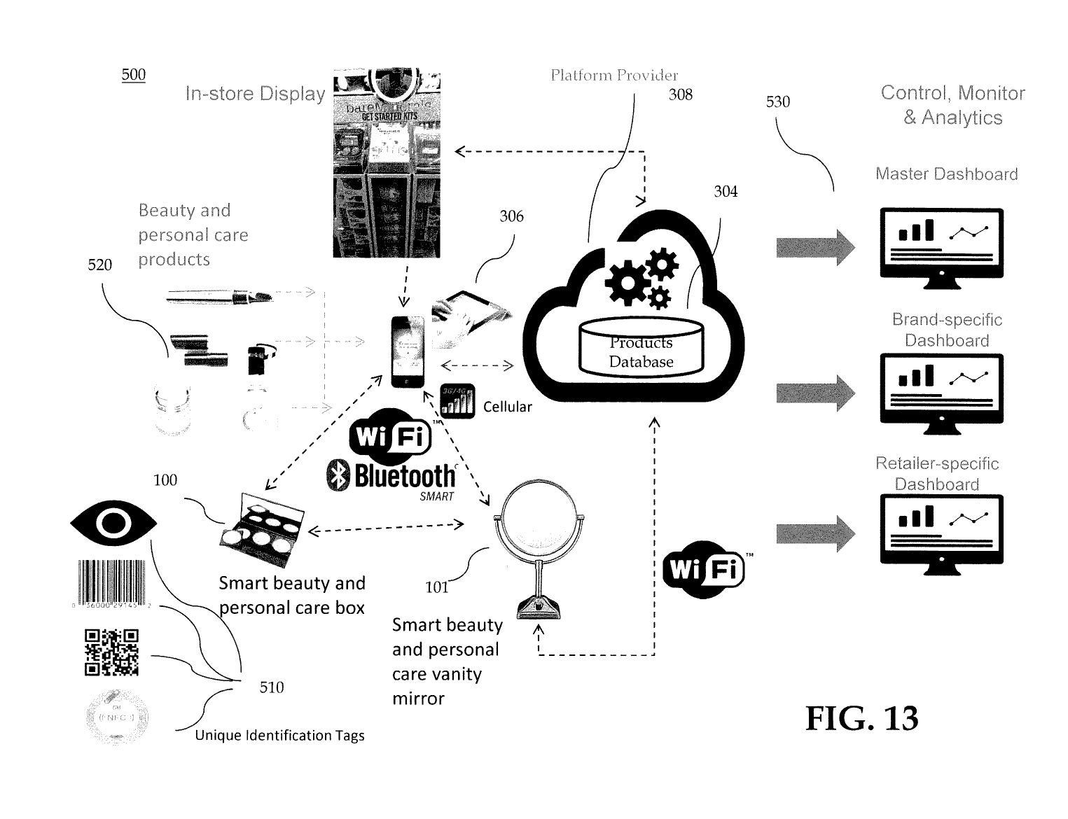

The smart looking glass 102 can enable a user to communicate with the smart beauty and personal care box 100 or vanity mirror 101. The high resolution digital camera 104 enables the user to take one or more high resolution pictures, and/or video. The RFID reader 106, and/or the NFC reader 138 enable the system to detect the unique identification tags corresponding to the beauty products situated within the product holder (e.g., trays 110A, 110B, etc.), so that the product information can be sent to the data storage cloud for inclusion in the reporting and considered in the algorithms. The detection may be achieved by the user picking the product and waving it in front of the smart beauty and personal care box 100 or vanity mirror 101 at a short distance. In the vanity mirror the high resolution auto focus digital camera 104 can be utilized as well to detect bar coding information 510 attached to the product (see FIG. 13). In this case, the image signal processing engine is used to read the bar code and algorithms on the controller 150 can further analyze and send this bar code information to the applications, which could reside on the CPU controller module 150 or remote via the Wi-Fi transceiver 124.

In alternate embodiments, detection of the product or cosmetic implement selected for use by the person may occur in a different manner. As seen in FIG. 1, each of the different products or product holders (e.g., trays 110A, 110B, etc.), may normally be positioned within the box 100 in close proximity to the electronics (i.e., close to the NFC reader 138). Since the near field communication (NFC) protocols typically establish communication when a tag is within a distance of less than 10 cm (3.9 inches) from the reader, the NFC tags of all of the trays may each be continuously detected by the NFC reader 138 while the unit is switched on, creating ambiguity as to which product may actually be selected and removed from the box by the user/consumer. Therefore, to resolve the potential ambiguity, the NFC tag of each cosmetic product may have a switch, such as, but not limited to, a spring biased pin protruding downward through an opening in the tag. When each of the trays (e.g., 110A, 110B, etc.) are housed within the box 100, the switch may be off (e.g., the biasing of the pin may be opposed by a surface of the housing, and the pin may be retracted inwardly), which may deactivate the NFC tag (i.e., place it in an idle state), so that the reader 138 may not detect any of the trays when stored in the box. Once a tray (e.g., tray 110A) is taken out from the box 100, the NFC tag may automatically be switched on (e.g., the pin will be biased outwardly, activating the tag of the removed product tray). The NFC ID tag may then be automatically detected by the NFC reader when held within its range. In the case where a user-consumer may remove two of more trays, while deciding which may be preferred for a particular day/event, and subsequently places one tray back in the box or on a vanity counter top, its NFC tag will become deactivated, and only the tag of the tray being held by the user-consumer will be detected by the reader. If the user continues to hold two trays for comparison, the system may provide the user with data (audio, or graphical information on the screen) regarding the two different products, to assist the person in making a final selection. Where RFID tags may be used, the box 100 may have an RF reader that utilizes a directional antenna that may be focused (e.g., outwardly from the plane of the mirror 102) which may, in ordinary use, be angled upwardly towards the face of the user/consumer and away from the trays (see FIG. 2). Therefore, when the unit is powered on, the RF reader would not sense the RFID tags of the trays stored in the box 100, as they would not be within the field of view of the antenna, and the RFID reader may only sense the tag of the tray held by the user before the mirror. The gain of the antenna may also be set to only read tags that are in close proximity to the box 100 (e.g., within a couple of feet of the box).

Each of the product interchangeable holders (e.g., trays 110A, 110B, etc.) may contain at least one beauty product. The stylus 116 may also be used to communicate with and control the SBPC box and local and remote applications, in the instance that a touch screen version of the smart looking glass 102 is utilized. The microphone 120 may enable the user to communicate voice instructions to the smart beauty and personal care box 100 or vanity mirror 101. The speaker 122 may enable the user to hear communication messages coming out of the smart beauty and personal care box 100 or vanity mirror 101.

The power supply unit 134 may provide a battery enabled backup power supply to the smart beauty and personal care box 100 or vanity mirror 101. The electrical cable 136 may provide a direct power supply to the smart beauty and personal care box 100 or vanity mirror 101 when connected to a power supply. The in circuit testing connector 126 allows for electronic module testing or trouble shooting performance issues.

The USB port 122, the Wi-Fi transceiver 124 and the Bluetooth transceiver 128 or a combination thereof enables the SBPC box 100 or vanity mirror 101 to communicate in real time with applications resides outside the SBPC box on a smart mobile or on other devices. The above mentioned approaches may also enable the smart beauty and personal care box 100 to communicate with a remotely located product database of the cosmetics company.

The smart beauty and personal care box 100 or vanity mirror 101 may also include the CPU 150 and memory storage (volatile and non-volatile) that enables the SBPC box to function as the smart device. The memory storage 152 may enable the smart beauty and personal care box 100 to store a plurality of information. The push button 158 may also enable the user to also take at least one image or video or combination thereof. The LED 160 may enable the smart beauty and personal care box 100 or vanity mirror 101 to signal its functioning status.

FIG. 2 shows the smart beauty and personal care vanity mirror 101. The smart beauty and personal care vanity mirror 101 may be constructed to include the same functionality as the smart beauty and personal care box, but without having the product housed therein. In both cases the use scenario is the same, e.g., in that the user will pick a tagged product, wave it close to the mirror so it can be read by one of the methods described above, then apply the product, take picture or video during and after the application of the product, use multiple applications that are residing on a smart mobile device to make decisions and further send the image or the video to friends and/or save on a server.

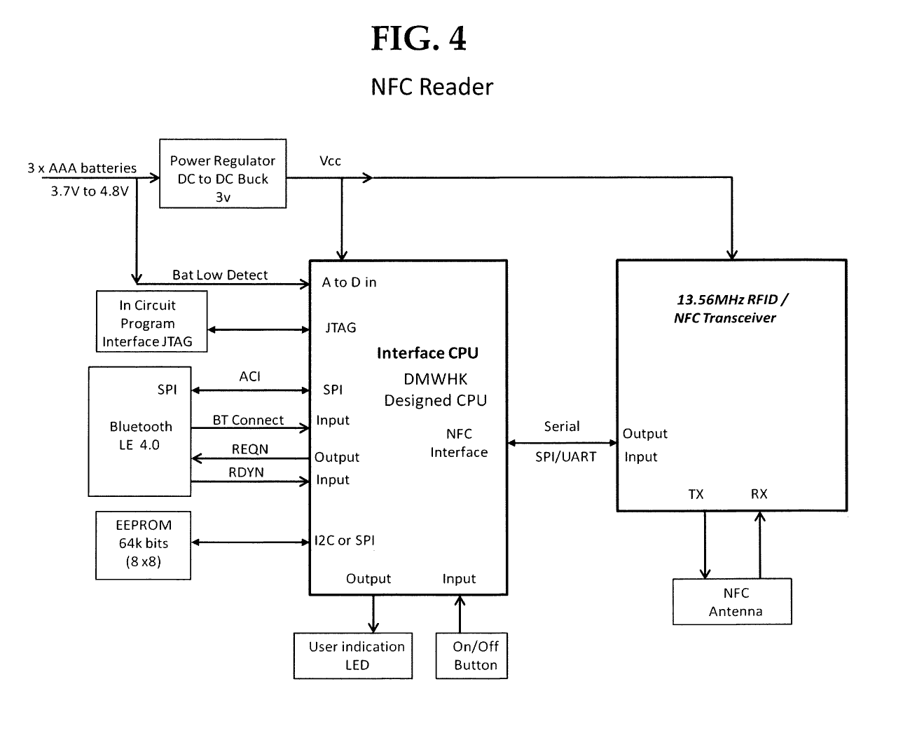

FIG. 3 illustrates a smart beauty and personal care box and vanity mirror, component block diagram of digital camera module embodiment of the present invention; it illustrates the various components that make up the camera module including an integrated 2 Mp (1600×1200) with 24 bit color depth, auto focus camera including lens, image sensor array, image processor and I/O interface. The camera module and supporting processors will handle all control function for the imaging taking operation and transfer from the camera module via bluetooth.

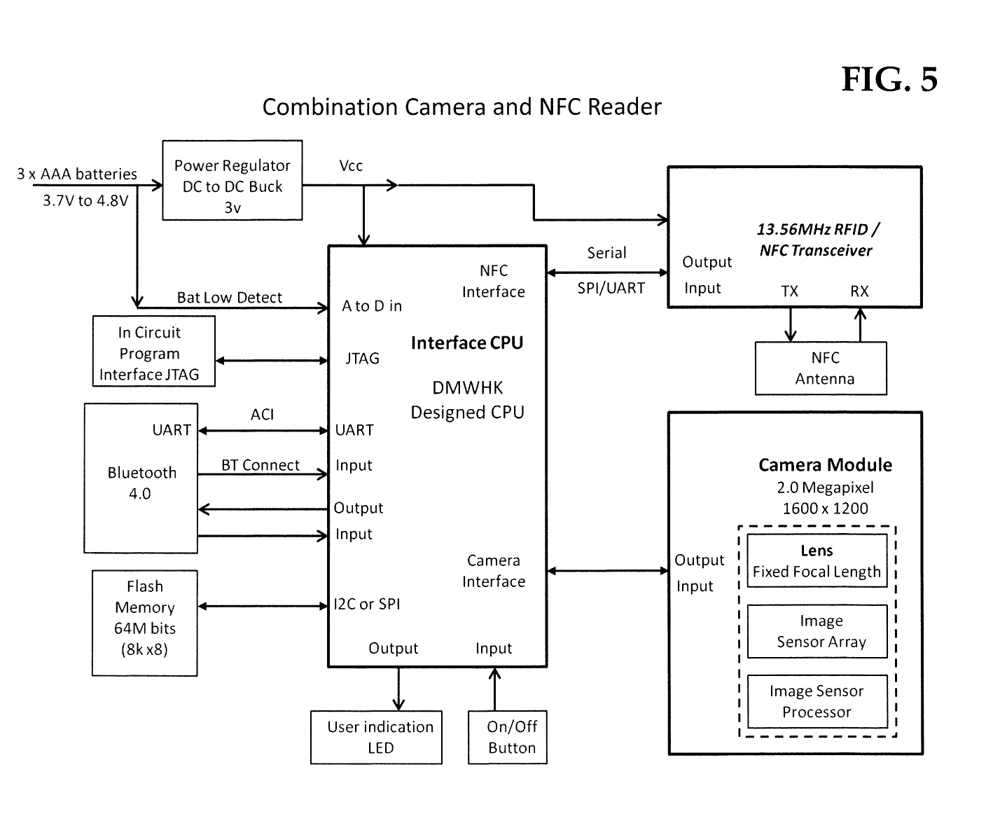

FIG. 4 illustrates a smart beauty and personal care box and vanity mirror, component block diagram of NFC Reader module 138 embodiment of the present invention; it illustrates the various components that make up the NFC Reader module including the NFC antenna 139.

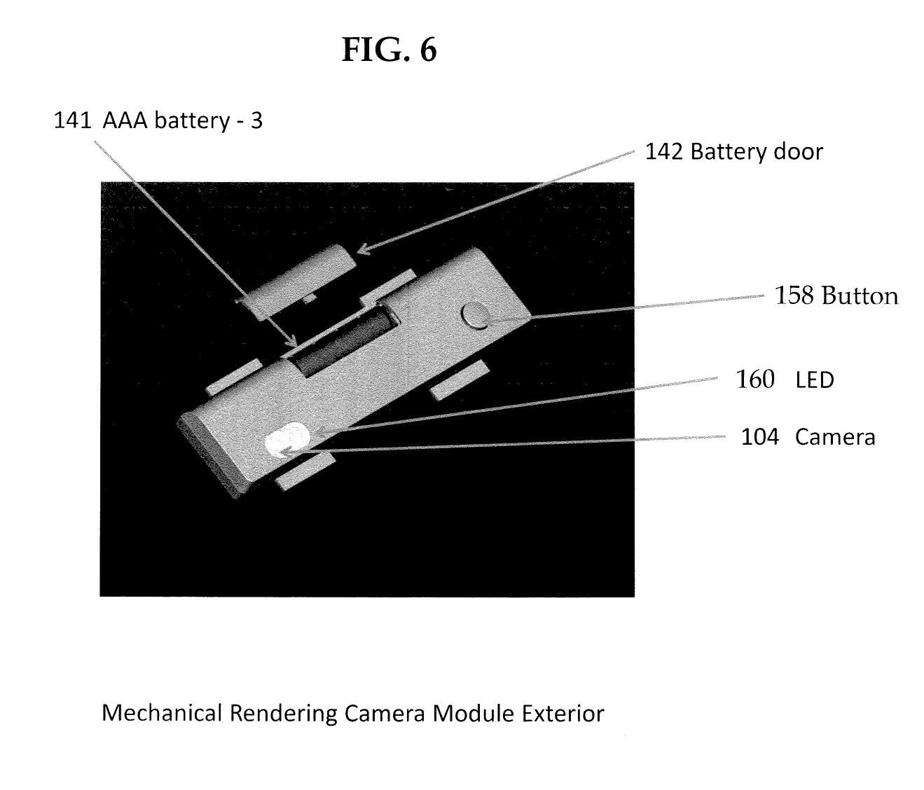

FIG. 5 illustrates a smart beauty and personal care box and vanity mirror, component block diagram of the module that consists of both the Camera and NFC modules embodiment of the present invention; it illustrates the various components integrated from FIGS. 3 and 4 into a single module.

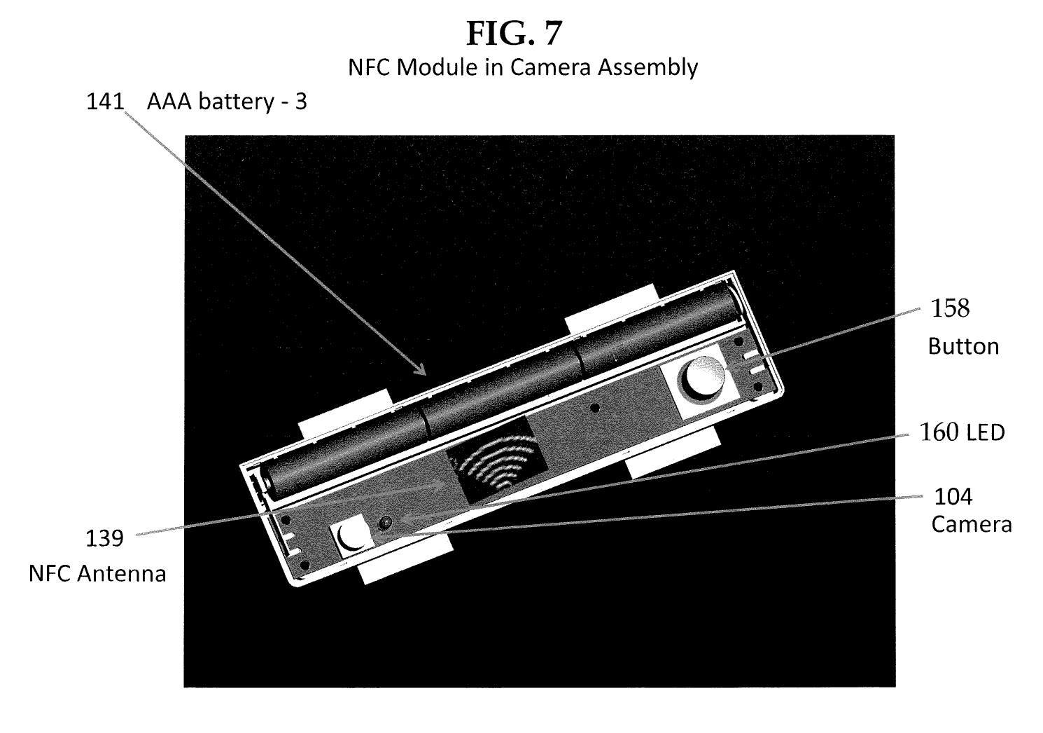

FIG. 6 illustrates a smart beauty and personal care box mechanical rendering of the camera module exterior. The smart beauty and care box 100 includes 3 AAA batteries, sliding battery door 142, 158 button to trigger camera, 160 LED indicator and 104 camera.

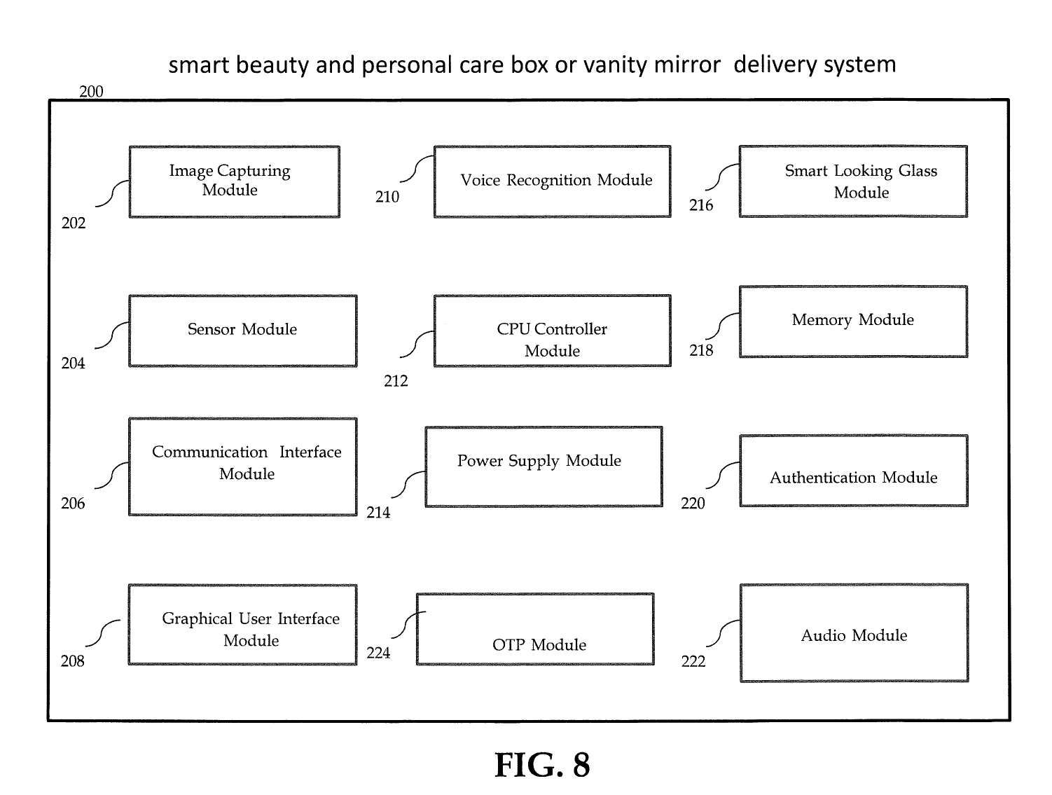

FIG. 7 illustrates a smart beauty and personal care box mechanical rendering of the camera module exterior in FIG. 6 with layout for the NFC module in the Fi

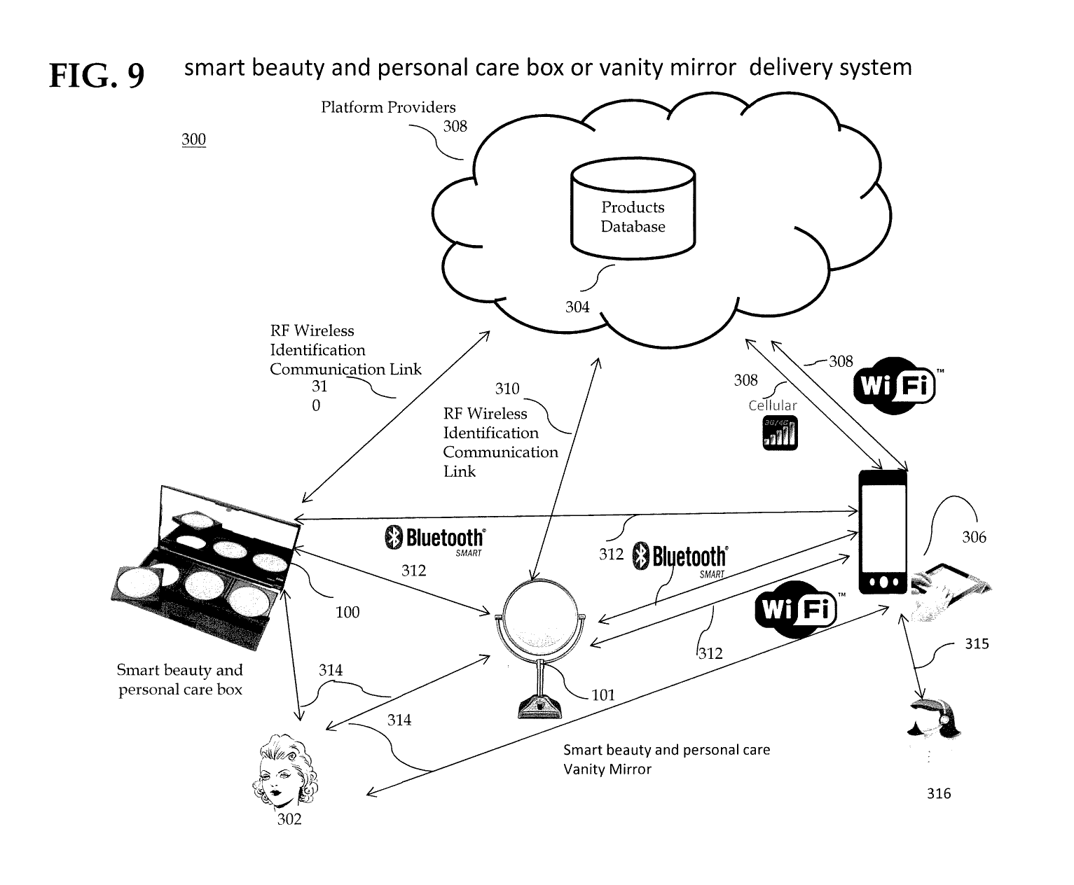

FIG. 8 illustrates a functional block diagram of the smart beauty and personal care box 100 delivery system, according to an embodiment of the present invention. The smart beauty and personal care box 100 and Vanity Mirror 101 includes an image capturing module 202, a sensor module 204, a communication interface module 206, a graphical user interface (GUI) module 208, a voice recognition module 210, a controller module 212, a power supply module 214, a smart looking glass module 216, a memory module 218, an authentication module 220, an audio module 222, and an OTP module 224 any or all of which may side in the box or in the Application on the mobile device.

The image capturing module 202 is configured to capture images of a user. The image capturing module 202 may be at least the high resolution digital camera 104. The high resolution digital camera 104 may also include a scanner. The high resolution digital camera 104 may be a system embedded camera. The high resolution digital camera 104 may also be a high resolution digital camera which may get attached to the smart beauty and personal care box 100 and Vanity Mirror 101 separately via one of the communication interfaces 122, 124, 128, or a combination thereof.

The sensor module 204 is configured to detect the beauty product selected by the user from the smart beauty and personal care box 100 and Vanity Mirror 101. The sensor module 204 may at least be the RFID detector 106. The RFID detector 103 may detect which product the user is using by detecting at least one unique identification tag of the beauty product. The smart beauty and personal care box 100 may be further configured to detect the beauty products from the smart beauty and personal care box 100 by any other known sensor in the art.

The communication interface module 206 is configured to provide communication at least between the smart beauty and personal care box 100 and Vanity Mirror 101 delivery system and the user, and between the smart beauty and personal care box 100 and Vanity Mirror 101 and the remote product database, and between the smart beauty and personal care box 100 or vanity mirror 101 and applications on a smart mobile device or a combination thereof. The communication interface module 206 may interact both with the user and with the remotely located product database or a combination thereof with at least the USB port 122, the Bluetooth 128, the Wi-Fi detector 124, or a combination thereof. The communication interface module 206 may also enable a communication link between the smart beauty and personal care box 100 and a smart phone via a mobile application. The communication link between the smart beauty and personal care box 100 and Vanity Mirror 101 and the smart phone may be formed with the Wi-Fi transceiver 124 or the Bluetooth transceiver or a combination thereof

The communication interface module 206 may also provide communications with a plurality of separate beauty product related applications provided by a plurality of different cosmetics companies. The plurality of different cosmetics companies may provide their customers with the plurality of beauty product related applications which may run on a plurality of smart devices thus acting as a central hub.

The GUI module 208 is configured to provide interactive animated displays. The animated displays may be at least a virtual product catalogue of beauty products which are not physically present in the smart beauty and personal care box 100 and Vanity Mirror 101. The system may propose to the user a virtual catalogue of beauty products in order to give the user more options in altering personal appearance.

In one embodiment, the GUI module 208 may also provide the user with at least a provision to share, capture, and download the images via at least one icon. In another embodiment, the GUI module 208 may also provide a smart looking glass icon to at least activate or deactivate the smart looking glass 102. When the GUI module 208 deactivates the smart looking glass 102, the smart looking glass 102 may act as a normal mirror.

The voice recognition module 210 is configured to accept at least one voice instruction from the person using the smart beauty and personal care box 100, wherein the voice instructions may be at least a share command, a capture command or a download command. In one embodiment, the voice recognition module 210 may also be utilized for authentication purposes.

The controller module 212 is configured to control at least one of the other modules located inside the smart beauty and personal care box 100 and Vanity Mirror 101, wherein the other modules may at least be the image capturing module 202, the sensor module 204, the communication interface module 206, the graphical user interface (GUI) module 208, the voice recognition module 210, the power supply module 214, the smart looking glass module 216, the memory module 218, the authentication module 220, and the audio module 222.

The power supply module 214 is configured to provide a constant power supply to the smart beauty and personal care box 100 and Vanity Mirror 101, wherein the modes of power supply may be at least battery operated or electrically operated.

The smart looking glass module 216 is configured to control the smart looking glass 102 when configured as more than just an ordinary mirror, because the smart looking glass 102 used on the box may at least be: a normal mirror, a semi-transparent mirror, a LCD screen, a TFT screen, a touch screen, or a combination thereof. The smart looking glass 102 may also allow the user to at least use the stylus 116 or their fingers or a combination thereof to communicate their preferences to the smart beauty and personal care box 100 and Vanity Mirror 101.

In one embodiment, the smart looking glass 102 may further display received suggestions from the system on the products available in the smart beauty and personal care box 100 or vanity mirror 101, wherein the suggestions may also include information about other makeup products which may not be present in the smart beauty and personal care box 100 but virtually available in the database of the manufacturer.

In another embodiment, the smart looking glass 102 may also display the enhanced makeover images, wherein the enhancement of the images maybe done by the user based on the received suggestions from the system wherein the enhanced makeover may consist at least a physical makeover, a virtual makeover or a combination thereof. The virtual makeover may broadly include the system providing a virtually enhanced image to the user, based on the user's attributes such as skin tone, dress style, time-of-day, lighting, weather, activity, etc.

The memory module 218 is configured to provide a memory storage to store a plurality of information wherein the plurality of information may at least be user information and preferences, information related to the specific products commonly applied by the user in the past, or past interactions; the stored information may allow smart, machine driven, decision making and choices/suggestions to be delivered to this user interactively or off line.

In one embodiment, the memory module 218 may also store at least an application software and an operating system wherein the operating system may be anything popularly known in the state of the art. In another embodiment, the memory module 218 may also be able to store the images captured by the image capturing module 202. The memory module 218 may also store the images transferred by the user to the smart beauty and personal care box 100 or vanity mirror 101 by the USB port 122 or via the communication interface module 206, wherein the communication interface module 206 may at least be the Bluetooth 128, the NFC port 138, the Wi-Fi detector 124, the RF port 140 or a combination thereof.

The authentication module 220 is configured to provide the user access to the smart beauty and personal care box 100 or vanity mirror 101. The authentication module 220 may consist of at least a biometric recognition, a PIN recognition, a pattern recognition, a pass-code recognition, the OTP recognition, or a combination thereof. The authentication procedure would apply at least one of the biometric recognition, the PIN recognition, the pattern recognition, the pass-code recognition, the OTP recognition or a combination thereof. The authentication module 220 may also have the provision of generating an alert directed towards the user registered mobile number in case the authentication procedure fails a predetermined number of times.

In one embodiment, the authentication module 220 provided OTP recognition may include generation of a unique OTP which may be shared with the user's registered mobile number, wherein the OTP may be generated by the OTP module 224. The authentication module 220 may provide the user with access to the smart beauty and personal care box 100 or vanity mirror 101 upon matching the user entered OTP with the system generated OTP.

In another embodiment, the authentication module 220 provided biometric recognition may at least be a retina recognition, an iris recognition, a face recognition, a finger printing recognition, a signature recognition, or a combination thereof. The authentication module 220 may also recognize the PIN and the pre-defined pass-code for the user who may access the smart beauty and personal care box 100 or vanity mirror 101 wherein the PIN may be only numerical whereas the pass-code may be an alphanumeric code.

The audio module 222 is configured to provide audio outputs to the user, wherein the audio module 222 may include a built-in speaker.

The OTP module 224 is configured to generate the unique OTP which the OTP module 224 may direct towards the user registered mobile number for authentication purposes.

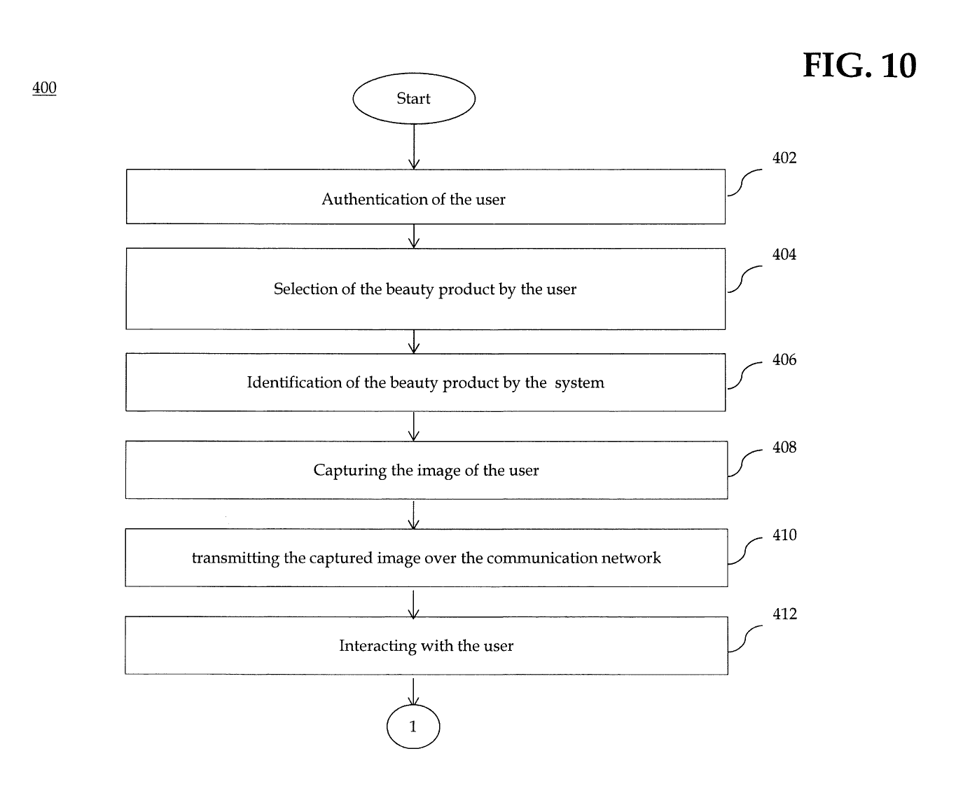

FIG. 9 illustrates a representation of a possible implementation scenario in which a communication session path is formed between the smart beauty and personal care box 100 and/or the vanity mirror 101, and a product database 304 which is part of the platform provider 308 services cloud, according to an embodiment of the present invention. The communication path can be via a RF wireless communication link 310, which is a NFC or RFID, or indirectly via a smart phone interface 312, which is Wi-Fi or Bluetooth, and then from the smart phone to the platform provider 308 via Wi-Fi or Cellular link. The product database 304 is a remote database located inside a platform provider network 308 and includes a plurality of product related information wherein the product related information may include at least product categories, product types, product usage, any new product launch, product popularity and so on. A user 302 may access the plurality of product related information from the remotely located product database 304 in real time via using the smart beauty and personal care box 100 or vanity mirror 101 delivery system.

The user 302 may communicate with the smart beauty and personal care box 100 using a real time communication link 314 or the box peripherals. The smart beauty and personal care box 100 or vanity mirror 101 and the product database 304 may communicate using a real time communication link 310. The communication between the smart beauty and personal care box 100 or vanity mirror 101 and the smart phone 306 is achieved by a separate real time communication link 312. The communication link 312 is a Bluetooth link and can also be Wi-Fi. The communication link between the smart beauty and personal care box or vanity mirror 101 and the smart phone enables sending and receiving information to and from applications on the smart phone, including and not limited to, multimedia, voice, video, session information, device control information, application control information. This link may enable the smart looking glass display 102 to be the remote mobile touch display input and output, such that any application running on the mobile sees the smart looking glass display as its current active display for interactive session with a user.

The real time communication link 314 between the user 302 and the smart beauty and personal care box 100 or vanity mirror 101 may be provided using the Bluetooth 128, Wi-Fi transceiver 124 or a combination thereof. The real time communication link 310 formed between the smart beauty and personal care box 100 or vanity mirror 101 and the product database 304 which is remotely located inside the platform provider network 308 may be provided by the Wi-Fi transceiver 124 or a Bluetooth interface or a combination thereof. The real time communication link 312 formed in between the smart beauty and personal care box 100 or vanity mirror 101 and the smart phone 306 may be provided by the Wi-Fi transceiver 124 or a Bluetooth interface or a combination thereof. The real time communication link 310 formed between the smart beauty and personal care box 100 or vanity mirror 101 and the product database 304 which is remotely located inside the platform provider 308 or located in the cloud platform providers network may be provided via the real time communication link 312 via the smart phone, using the smart phone application as an interface into the network cloud.

The smart phone 306 running the smart beauty and personal care box 100 or vanity mirror 101 delivery system applications provides a plurality of applications that may be originated by various companies. The present invention provides a single unified interface to the smart beauty and personal care box, eliminating the need for the user to interact with plurality of applications and interfaces.

The real time communication links 314 formed in between the user 302 and the smart beauty and personal care box 100 or vanity mirror 101 delivery system can be Wi-Fi and/or Bluetooth. The system also allows for direct third party communication 315 via the smart phone to have another user or smart beauty and personal care system makeup analyst/artist 316 to give direct communication via text or voice to answer questions, make product suggestions and walk the user through a complete makeup session.

The real time communication link 310 formed in between the smart beauty and personal care box 100 and the remotely product database 304 can be Wi-Fi. The real-time communication link between the smart beauty and personal care box 100 or vanity mirror 101 and the smart mobile devices 306 can be Bluetooth or Wi-Fi. The communication link 310 between the smart mobile devices 306 and the platform provider 308 can be Wi-Fi or cellular. These links may enable the user 302 to fetch a plurality of crucial product related information directly from the product database 304. The platform provider 308 which is storing a plurality of product related information in the product database 304 may have a plurality of trade secrets about the products they manufacture. The trade secrets may at least include the appropriate way to apply their products depending on the condition of the user skin, what should be the environmental condition to get the best output after applying the beauty products, the “right look” for the user depending upon the user skin color and complexion, and what “makeup tone” produces the “right statement of look” the user wants to showcase or a combination thereof. All these crucial business information may get shared by the smart beauty and personal care box 100 with the user 302 in real time to make smart decision making after fetching that information from the product database 304.

FIG. 9 further illustrates a possible implementation scenario in which a communication session path is formed between the smart beauty and personal care vanity mirror 101, and a product database 304 according to an embodiment of the present invention. The communication path can be directly via a real time communication link 310 to the beauty makeover box, or via a smart phone interface 312. The product database 304 is a remote database located inside a platform provider network 308 and includes a plurality of product related information wherein the product related information may include at least product categories, product types, product usage, any new product launch, product popularity and so on. A user 302 may access the plurality of product related information from the remotely located product database 304 in real time via using the smart beauty and personal care vanity mirror 102 delivery system.

From communication interface perspective, the smart beauty and personal care vanity mirror 101, in this example embodiment, is acting in similar manner to the smart beauty and personal care box 100. The user 302 may communicate with the smart beauty and personal care vanity mirror 102 via the real time communication link 314 and/or directly with the smart beauty and personal care vanity mirror peripherals. The smart beauty and personal care vanity mirror 101 and the product database 304 may communicate using a real time communication link 310. The communication between the smart beauty and personal care vanity mirror 101 and the smart phone 306 is achieved by a separate real time communication link 312.

The real time communication link 314 between the user 302 and the smart beauty and personal care vanity mirror 101 may be provided using the Bluetooth 128 or Wi-Fi or a combination thereof. The real time communication link 310 formed between the smart beauty and personal care vanity mirror 101 and the product database 304 which is remotely located inside the platform provider network 308 may be provided by the Wi-Fi interface 124 or a Bluetooth interface or a combination thereof. The real time communication link 312 formed in between the smart beauty and personal care vanity mirror 101 and the smart phone 306 may be provided by the Wi-Fi interface 124 or a Bluetooth interface or a combination thereof where the smart beauty and personal care vanity mirror 101 and or user 302 gets connected with the smart phone 306 in real time via linking mobile application. The real time communication link 310 formed between the smart beauty and personal care vanity mirror 101 and the product database 304 which is remotely located inside the platform provider network 308 may be provided via the real time communication link 312 via the smart phone, using the smart phone application as an interface into the network cloud.

Similarly to the smart beauty and personal care box 100, the real time communication links 314 formed in between the user 302 and the smart beauty and personal care vanity mirror 101 and the real time communication link 310 formed in between the smart beauty and personal care vanity mirror 101 and the remotely product database 304 may enable the user 302 to fetch a plurality of crucial product related information directly from the product database 304.

Further, link between the smart beauty and personal care vanity mirror 102 and the smart beauty and personal care box 100 enables the user to access and share products and information between the two devices. In one embodiment, the smart beauty and personal care vanity mirror 101 acts as a smart beauty and personal care box 100 without the attached product. In this example embodiment the smart beauty and personal care vanity mirror 101 provides all the functionality of the smart beauty and personal care box 100 that is not directly associated with housed products, holders and holder management facilities. The smart phone 306 provides plurality of applications that can connect and interact with the smart beauty and personal care vanity mirror 101.

The world view depicted in FIG. 9 is an Internet of Things, where every device can be connected and be interacting with every other device in the smart beauty delivery system, including interaction between a tagged beauty product, a tagged cosmetics tool such as a scissors or nail clipper, the smart beauty and personal care box 100, the smart beauty and personal care vanity mirror 101, and applications and connectivity enable devices like smart phones, tablets and smart pads, and data-bases and computer systems located remotely in data centers and/or stores and manufacturing and distribution facilities world wide.

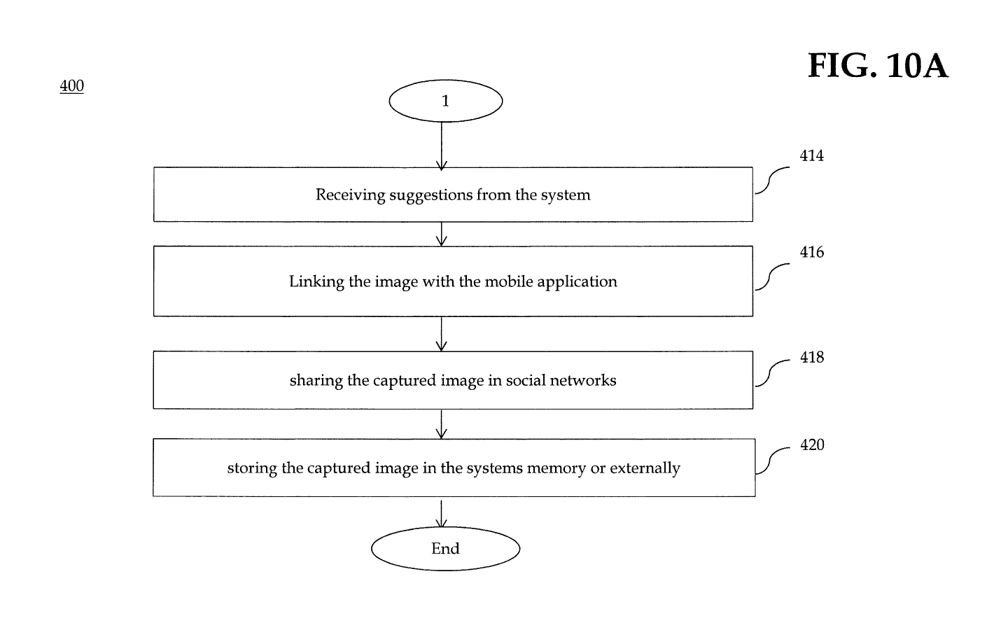

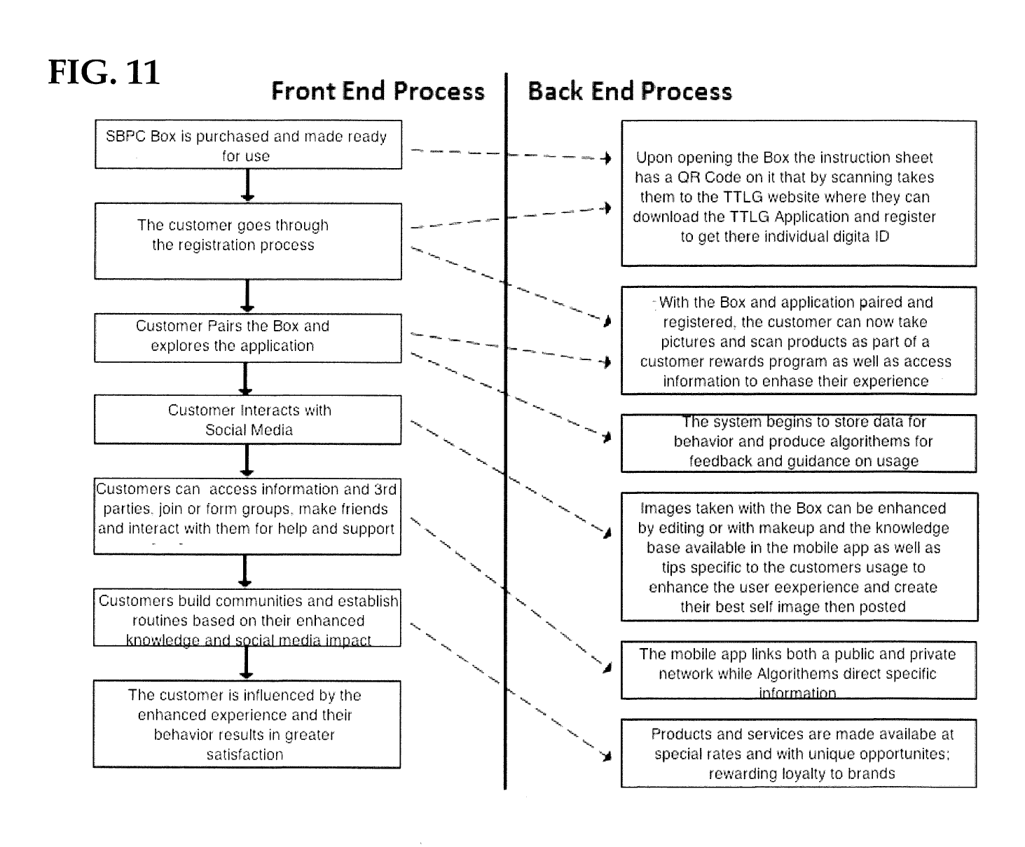

FIG. 10 depicts a flow chart of a method for managing a communication session in the smart beauty and personal care box 100 or vanity mirror 101, according to an embodiment of the present invention.

At step 402, after a user opens up the smart beauty and personal care box 100, the user needs to be authenticated by the smart beauty and personal care box 100. The authentication module 220 performs this authentication of the user. The authentication module 220 may perform the user authentication at least via the biometric recognition, the PIN recognition, the pattern recognition, the pass-code recognition, the OTP recognition, or a combination thereof. The authentication module 220 may also generate an alert directed towards the user registered mobile number in case the applied authentication procedure fails a predetermined number of times.

In one embodiment of the present invention, the authentication module 220 may provide authentication via OTP recognition. The OTP module 224 may generate a unique OTP which may be shared with the user's registered mobile number. The authentication module 220 may provide the user with access to the smart beauty and personal care box 100 after matching the user entered OTP with the system generated OTP.

In another embodiment, the authentication module 220 may also provide biometric recognition, wherein the biometric recognition may at least be a retina recognition, an iris recognition, a face recognition, a finger printing recognition, a signature recognition, or a combination thereof.

Further, in another embodiment, the authentication module 220 may also recognize the PIN and the pre-defined pass-code by the user who may access the smart beauty and personal care box 100 wherein the PIN may be only numerical whereas the pass-code may be an alphanumeric code.

At step 404, after successful authentication by the smart beauty and personal care box 100, the user can choose at least one beauty product present in the smart beauty and personal care box 100 or vanity mirror 101, wherein the beauty product may at least be the lip stick, the lip gloss, the lip liner, the lip plumper, the lip balm, the lip conditioner, the lip primer, the lip booster, the concealer, the foundation, the mascara, the nail polish, the eyebrow pencil, and so on.

At step 406, the smart beauty and personal care box 100 or vanity mirror 101 may identify at least one of the chosen beauty products, where the identification procedure may include identifying the unique identification tag linked with the product by using at least the RFID detector 106 or NFC 138 or any other known in the art.

At step 408, the smart beauty and personal care box 100 or vanity mirror 101 may capture an image of the user by using at least the digital camera 104 or any other image capturing device known in the art.

At step 410, the smart beauty and personal care box 100 or vanity mirror 101 may transmit the captured image linking via the mobile application to a database.

At step 412, the smart beauty and personal care box 100 or vanity mirror 101 may interact with the user regarding the captured image wherein the interaction may at least be the video interaction or the audio interaction or the combination thereof. The video interaction may be provided by the GUI module 208 and the audio interaction may be provided by the audio module 222.

At step 414, the smart beauty and personal care box 100 or vanity mirror 101 may provide suggestions to the user to enhance the applied makeup wherein the enhancement of the makeup may be the physical enhancement of the makeup done by the user using the available beauty products based on the suggestions provided by the smart beauty and personal care box 100 or vanity mirror 101.

In another embodiment the smart beauty and personal care box 100 or vanity mirror 101 may also provide suggestions to the user to enhance the makeup of the captured image by applying a makeup product not present in the smart beauty and personal care box 100. The smart beauty and personal care box 100 may then provide the user with a virtual list of available products from which the user may choose the suggested beauty product color and virtually enhance the captured image.

At step 416, the user may choose to link the enhanced picture with a mobile application, wherein the mobile application provided by the cosmetic company itself will link via the system's mobile application.

At step 418, the user may share the enhanced image in social networks.

At step 420, the user may also choose to store the enhanced picture in the memory of the smart beauty and personal care box 100 or vanity mirror 101.

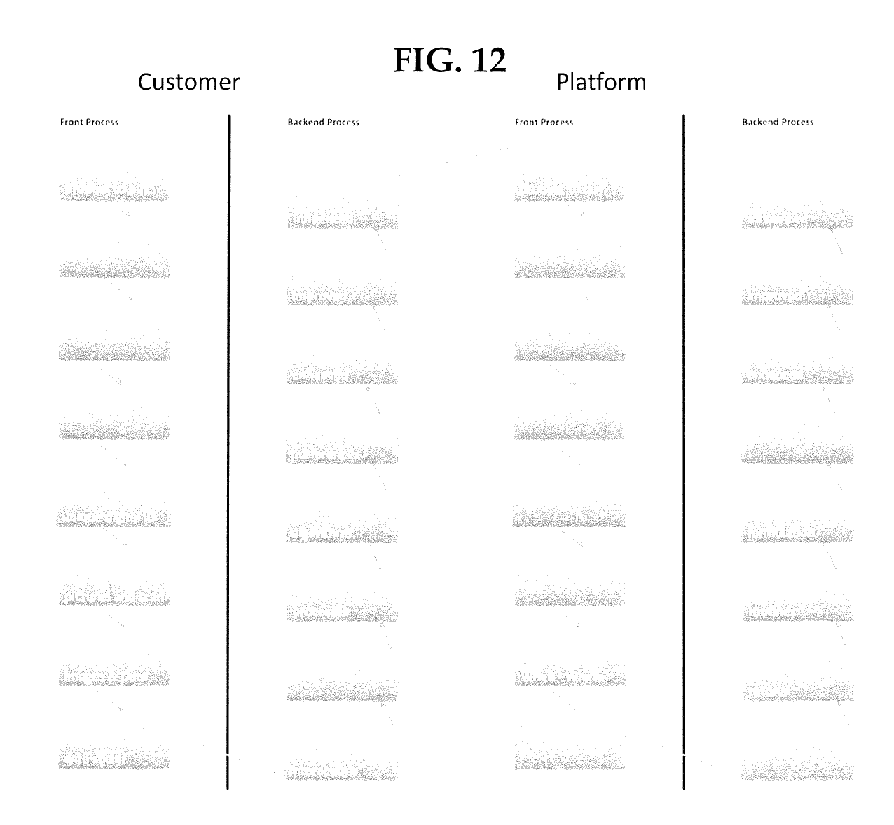

FIGS. 11 and 12 depicts a flow chart of a method for managing an interchange of smart communication via application programming and algorithms created from the data collected and the crowd sourcing relationship between the platform and the user. This session is between the smart beauty and personal care box 100 or vanity mirror 101; and the application on the mobile unit and the cloud platform according to an embodiment of the present invention. The result is the process that takes a customer from the point of purchase to satisfaction with the total process embodied in the smart beauty and personal care delivery system.

The world view depicted in FIG. 13 further illustrates a possible implementation scenario in which multiple IoT devices are connected via set of sensors 510 that can include barcode scanner, picture scanner (face and object recognition), NFC, Bluetooth and more, into a smart beauty and personal care box 100 or a smart beauty and personal care vanity mirror 101. The smart beauty and personal care devices (box and/or vanity mirror 100, 101) are further connected to the variety of smart phones and smart communication devises. The smart beauty and personal care devices further connected to the network and can access databases and applications 304 via any of their connections. The IoT system is fully connected to backend and support systems to enable manufacturing, distribution control systems to utilize input information. 530 is the system dashboard and monitoring systems examples, showing clearly the support for multiple product brands, vendors, retailors, manufacturing and distribution management systems.

In one possible embodiment, the present invention allows sharing of revenue between brands, retailors, and manufacturing and distribution organizations. The cloud of applications in support of the smart beauty and personal care devices (box and/or vanity mirror 100, 101) monitors all interactions of users with the system and allows tagging of any transaction associated with any and all beauty and personal care products within the IoT cloud. This tagging including, but not limited to, transaction origination, status and competition, financials and other information that was exchanged to complete the transaction, the different systems involved, the specifics of the product involved, the specific day and time associated with these transactions, and more information pertaining to management of these transactions and content.

In one possible embodiment, the smart tagging of the different beauty and personal care products allows for inventory management on a personal level, which is, every product can report to the system via the IoT interfaces, the its current level, and in return the system can let the users know that a specific product, for example, is running out and needs to be fulfilled. Further, a person can set an auto fulfillment command in the system to allow specific product or any product in their possession to be fulfilled upon expiration date or quantity.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the present invention has been presented for purposes of illustration and description. The foregoing is not intended to limit the present invention to the form or forms disclosed herein. In the foregoing Detailed Description for example, various features of the present invention are grouped together in one or more embodiments, configurations, or aspects for the purpose of streamlining the disclosure. The features of the embodiments, configurations, or aspects of the present invention may be combined in alternate embodiments, configurations, or aspects other than those discussed above. This method of disclosure is not to be interpreted as reflecting an intention that the present invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

We claim:

1. A cosmetics application system comprising:
a smart looking glass;
a housing comprising one or more openings;
one or more product holders configured to be respectively received in said one or more openings in said housing;
an ID tag respectively secured to each said product holder, each said ID tag configured to correspond to a cosmetic product in said respective product holder;
means for communicating data from said cosmetics application system over a network, and for receiving data over the network;
an ID tag reader configured to identify the cosmetic product in said respective product holder, by sensing said ID tag thereon when said product holder is positioned before said smart looking glass; and
wherein said system is configured to provide product information with respect to the cosmetic product of said sensed product holder.

2. The cosmetics application system according to claim 1, wherein said smart looking glass is configured as a display screen, with said system configured to provide said product information on said display screen, said product information comprising information on applying the cosmetic product of said identified holder onto a user of said system.

3. The cosmetics application system according to claim 1,
wherein said smart looking glass is configured as an integral mirror and a display screen; and
wherein said system is configured to provide said product information on said display screen, said product information comprising information on applying the cosmetic product of said identified holder onto a user of said system.

4. The cosmetics application system according to claim 1,
wherein said smart looking glass is configured as a mirror to reflect the image of a user of said system; and
wherein said system is configured to provide said product information over the network, said product information comprising notice of said sensed instance of said product holder.

5. The cosmetics application system according to claim 1,
wherein said system is configured to provide said product information over the network and to store said product information in a database of a memory, said product information comprising notice of each instance of said sensed product holder.

6. A cosmetics application system comprising:
a smart looking glass;
a housing configured to at least support said smart looking glass;
one or more cosmetic products;
an ID tag respectively secured to each of said one or more cosmetic products, and each said ID tag configured to correspond to said respective cosmetic product;
means for communicating data from said cosmetics application system over a network, and for receiving data over the network;
an ID tag reader configured to identify each said one or more cosmetic products, by sensing said ID tag thereon when a user-selected one of said cosmetic products is positioned before said smart looking glass; and
wherein said system is configured to provide product information with respect to said sensed cosmetic product.

7. The cosmetics application system according to claim 6,
wherein said system is configured to provide said product information over the network to a manufacturer of said sensed product, and to store said product information in a database of a memory of the manufacturer, said product information comprising notice of each instance of said sensed user-selected product.

8. The cosmetics application system according to claim 6, further comprising:
a camera configured to image a user of said system.

9. The cosmetics application system according to claim 8,
wherein said system is configured to communicate said image of the user over the network to a cosmetician, makeup artist, a makeup sales person, a dermatologist, non-professionals such as the user's family and friends or any other individual that may provide information or guidance with respect to the product;
and
wherein said system is further configured to receive, over the network, cosmetic application advice from the cosmetician, based on said image of the user.

10. The cosmetics application system according to claim 9,
wherein said smart looking glass is configured as a display screen; and
wherein said system is further configured to display said received cosmetic application advice on said display screen.

11. The cosmetics application system according to claim 9,
wherein said smart looking glass is configured as a combination integral mirror and a display screen;
wherein said system if further configured to display said received cosmetic application advice on said display screen.

12. The cosmetics application system according to claim 9, further comprising:
a microphone configured to communicate voice messages over the network, from the user to the cosmetician, makeup artist, a makeup sales person, a dermatologist, non-professionals such as the user's family and friends or any other individual that may provide information or guidance with respect to the product; and
a speaker configured to communicate audio messages from the cosmetician to the user.

13. The cosmetics application system according to claim 8,
wherein said smart looking glass is configured as a display screen, said display screen comprising a touch screen;
wherein said system is configured to display a camera icon within a graphic user interface (GUI) of said touch screen; and
wherein said system is configured for toggling of said camera icon to trigger said camera to capture one or more images of the user, and to transmit said one or more images over the network to a cosmetician, makeup artist, a makeup sales person, a dermatologist, non-professionals such as the user's family and friends or any other individual that may provide information or guidance with respect to the product.

14. The cosmetics application system according to claim 13 wherein said means for communicating is further configured for sending and receiving text messages between the user and the cosmetician, makeup artist, a makeup sales person, a dermatologist, non-professionals such as the user's family and friends or any other individual that may provide information or guidance with respect to the product.

15. The cosmetics application system according to claim 13 wherein said GUI of said system comprises:
an image storage icon, with said system configured for toggling of said image storage icon to store said one or more captured camera images in a system memory; and
an image view icon, with said system configured for toggling of said image view icon to display said one or more captured camera images stored in said memory on said display screen.

16. The cosmetics application system according to claim 13 wherein said GUI of said system comprises a social media icon, and wherein said system is configured for toggling of said social media icon to share said one of said images in a social network.

17. The cosmetics application system according to claim 13, wherein said GUI of said system comprises a tutorial icon, and wherein said system is configured for toggling of said tutorial icon to permit a user to select a tutorial for any of said one or more cosmetic products.

18. The cosmetics application system according to claim 8 further comprising a plurality of lights distributed about said smart looking glass, said plurality of lights configured to simulate one or more lighting conditions.

19. The cosmetics application system according to claim 18, wherein said system is configured to display a virtually enhanced version of said one or more camera images of the user, based upon: said lighting conditions; weather conditions; attributes of the user including skin tone, and dress style; and activity type.

20. The cosmetics application system according to claim 6, wherein said product information provided by said system for said sensed cosmetic product comprises a warning for usage of said sensed product beyond its expiration date.
